(19) United States
(12) Patent Application Publication
(10) Pub. No.: US 2026/0058478 A1
(43) Pub. Date: Feb. 26, 2026

(54) SYSTEM FOR CONTINUOUS, DEMAND-BASED ENERGY SUPPLY OF A BUILDING, METHOD FOR CONTROLLING A SYSTEM FOR CONTINUOUS, DEMAND-BASED ENERGY SUPPLY OF A BUILDING AND CONTROL UNIT FOR CONTROLLING A SYSTEM FOR CONTINUOUS, DEMAND-BASED ENERGY SUPPLY OF A BUILDING AND COMPUTER PROGRAM PRODUCT

(71) Applicant: GREENPEAK ENERGY GMBH, Grammetal (DE)

(72) Inventor: Phil-Gordan ZAMEIT, Grammetal (DE)

(21) Appl. No.: 19/107,357

(22) PCT Filed: Aug. 29, 2023
(86) PCT No.: PCT/EP2023/073706

§ 371 Date: Feb. 27, 2025

(30) Foreign Application Priority Data
Aug. 29, 2022 (DE) 10 2022 121 828.7

(51) Int. Cl. H02J 3/46; H02J 3/28

(52) U.S. Cl. CPC H02J 3/46; H02J 3/28; H02J 2300/24; H02J 2300/28; H02J 2300/30; H02J 2310/12

(57) ABSTRACT

The present disclosure relates to a system 1000 for continuous, demand-based energy supply of a building 2000, comprising: a first energy supply module 100 for providing an amount of energy of a first form of energy, a first energy converter module 200, which has a first, primary load-dependent energy converter 210 for primary load-dependent conversion of a part of the provided amount of energy of the first form of energy into a second form of energy that is different from the first form of energy, and a first energy storage 220/230 for storing an amount of energy of the second form of energy, a consumer module 600/800 that has at least one consumer of the building 2000 for consuming a demand-dependent amount of energy of the first form of energy and/or a demand-dependent amount of energy of the second form of energy, and a control unit 900 for controlling the modules of the system 1000, the system 1000 further comprising a second energy converter module 300 which has a second energy converter 310 for converting another part of the amount of energy of the first form of energy into a third form of energy different from the first and second forms of energy, wherein in the conversion of the other part of the amount of energy of the first form of energy into the third form of energy, at the same time a part of the other part of the amount of energy of the first form of energy is converted into the second form of energy, a second energy storage 320 for storing the amount of energy of the third form of energy, and a third energy converter 330/340 for converting a stored amount of energy of the third form of energy into the first form of energy, wherein when converting the stored amount of energy of the third form of energy into the first form of energy, a part of the amount of energy of the third form of energy is simultaneously converted into the second form of energy.

The present disclosure refers to a system for continuous, demand-based energy supply of a building, a method for controlling a system for continuous, demand-based energy supply of a building, a control unit for controlling a system for continuous, demand-based energy supply of a building and a computer program product.

### BACKGROUND

With regard to the optimal use of available energy and especially with regard to the potential effects of excessive, often unnecessary energy consumption, which leads, for example, to increased CO2 emissions in energy production and thus, for example, to a promotion of climate change, it is more than ever a target to use systems and machines, whose main task is, for example, the production of components or the provision of IT services (such as computer operations and/or storage options, etc.), for the generation of heat and thus for the heating of other areas, for example residential buildings and office buildings, but also barns etc.

Typically, these machines and facilities are operated with electrical energy, wherein a large portion of the electrical energy is converted into thermal energy (heat) by drives or large processor units. This thermal energy is primarily supplied exclusively as waste heat to the environment, in particular to the outside air, via respective cooling systems. This means that a significant part of the energy supplied to the system is released back into the environment unused, meaning that more resources than necessary have to be used to generate electrical energy and to heat the buildings.

Ways to use, for example, the waste heat from servers for other purposes through appropriately modeled water cooling instead of simply supplying it to the environment are known from the prior art.

In the context of the idea of using the waste heat from these machines and facilities for other purposes, the problem often arises that these machines or facilities sometimes do not operate continuously with the same load (primary load of producing components or primary load of carrying out computer operations, etc.), so that no continuous generation of thermal energy (as a kind of secondary load) can take place.

In some cases, the primary loads of the machines or facilities can be subject to such large fluctuations that a continuous provision of heat is not possible to supply a building, so that there is a need for a system that uses advantageously the fluctuations in overgeneration and undergeneration of electrical and thermal energy to ensure a continuous supply of electrical and thermal energy to a building.

In view of the above-described disadvantages, based on the above-described prior art, it is an object of the present application to provide an improved system for continuous, demand-based energy supply of a building and a correspondingly improved method for controlling the system for continuous, demand-based energy supply of the building, which avoids the problems and disadvantages of the already known solutions and instead makes the amount of energy produced continuously usable and storable.

### SUMMARY

The present disclosure relates to a system for continuous, demand-based energy supply of a building, a method for controlling a system for continuous, demand-based energy supply of a building, a control unit for controlling a system for continuous, demand-based energy supply of a building and a computer program product.

In particular, to solve the above-mentioned task, a system for continuous, demand-based energy supply of a building according to claim 1, a method for controlling a system for continuous, demand-based energy supply of a building according to claim 24, a control unit for controlling a system for continuous, demand-based energy supply of a building according to claim 33 and a computer program product according to claim 34 are proposed. The dependent claims relate to some exemplary preferred embodiments.

According to one aspect, an exemplary system for continuous, demand-based energy supply of a building is proposed, with a first energy supply module for providing an amount of energy of a first form of energy, a first energy converter module, which has a first, primary load-dependent energy converter for primary load-dependent conversion of a part of the provided amount of energy of the first form of energy into a second form of energy that is different from the first form of energy, and a first energy storage for storing an amount of energy of the second form of energy, a consumer module that has at least one consumer of the building for consuming a demand-dependent amount of energy of the first form of energy and/or a demand-dependent amount of energy of the second form of energy, and a control unit for controlling the modules of the system, the system further comprising a second energy converter module which has a second energy converter for converting another part of the amount of energy of the first form of energy into a third form of energy different from the first and second forms of energy, wherein in the conversion of the other part of the amount of energy of the first form of energy into the third form of energy, at the same time a part of the other part of the amount of energy of the first form of energy is converted into the second form of energy, a second energy storage for storing the amount of energy of the third form of energy, and a third energy converter for converting a stored amount of energy of the third form of energy into the first form of energy, wherein when converting the stored amount of energy of the third form of energy into the first form of energy, a part of the amount of energy of the third form of energy is simultaneously converted into the second form of energy.

In particular, the control unit can control the modules of the system in such a way that if the amount of energy of the first form of energy generated or provided by the first energy supply module is greater than the amount of energy of the first and second forms of energy consumed by the consumer module, the excess amount of energy is delayed or simultaneously stored in the first energy storage for storing the second form of energy and in the second energy storage for storing the third form of energy, and that if the amount of energy of the first form of energy generated or provided by the first energy supply module is smaller than the amount of energy of the first and the second form of energy consumed by the consumer module, the amount of energy stored in the first energy storage for storing the second form of energy and the amount of energy stored in the second energy storage for storing the third form of energy after being converted into an amount of energy of the first and/or the second form of energy is delayed or simultaneously emitted for consumption in the consumer module.

The control unit of the exemplary system can advantageously control the storage and discharging processes of the energy storage in such a way that the storage process of the energy storage of the second form of energy takes place simultaneously with the storage process of the energy storage of the third form of energy. Both delayed storage of the different forms of energy and storage one after the other are possible. The same applies to the discharging processes of the storage, which can also be timed. Various conditions can be used as a criterion/dependency (for example due to different efficiencies of the individual forms of energy to the other form of energy when converting or the demand for a corresponding form of energy for consumption in the building, etc.) as to when which storage is loaded or discharged and how.

Through the exemplary system, despite the primary load-dependent conversion of, for example, electrical energy (for example, first form of energy) into, for example, thermal energy (for example, second form of energy), which can sometimes lead to very fluctuating production and thus fluctuating provision of thermal energy (heat) for supplying the building, a continuous supply of electrical and thermal energy to the building can be ensured.

The use of the third form of energy (e.g. chemical energy) as a type of compensation form of energy for the demand for the first form of energy (e.g. electrical energy) and/or the second form of energy (e.g. thermal energy) for continuous supply has a surprisingly positive effect on this system of machines and systems, the building and its technical units/modules.

In the event of excess energy (there is more energy available than is consumed), especially excess electrical energy, the excess energy can be converted into chemical energy and stored for later times when, for example, electrical or thermal energy is underprovided to supply machines and systems as well as for supplying the building. If necessary, electrical and thermal energy can be recovered from the stored chemical energy and used advantageously for the continuous supply of the machines and systems as well as the building and/or their technical units/modules.

A significant advantage of this method is, among other things, the possibility of storing comparatively large amounts of chemical energy in a comparatively small space, since chemical energy (for example gases such as hydrogen, methane, etc.) can be easily compressed under moderate pressure (for example in the range of 30 to 40 bar), wherein the amount of energy required to compress the gases to reach these pressure levels (for example an amount of electrical energy used for this) is comparatively moderate.

Another advantage of this method is the possibility of using gases such as hydrogen in several ways to recover thermal or electrical energy. One variant would be, for example, the combustion of the hydrogen in a corresponding device, for example in a combined heat and power plant, another variant would be, for example, the use of the hydrogen in a fuel cell.

The so-called cold combustion in the fuel cell also produces waste heat of around 55° C. In a combined heat and power plant, the exhaust gas temperatures are usually between 300° C. and 400° C. In both cases, waste heat, on the one hand in the low to medium temperature range and on the other hand in the high temperature range, as well as electrical energy can be provided for further use in the exemplary system.

A continuous supply of electrical and thermal energy to the building can be ensured in various ways and in particular with regard to which form of energy (thermal or electrical) and in what quality is additionally required, despite the fluctuating provision or generation of thermal energy (due to the primary load-dependency of the first energy converter), and, thereby, the operation of the machines/equipment (e.g. machine tools, computing units, etc.) as well as the technical units/modules (e.g. the heat pump) of the building and thus of the exemplary system are ensured or supported.

The exemplary system makes it possible to use the respective advantages and disadvantages of the various forms of energy such as electrical (for example first form of energy), thermal (for example second form of energy) and chemical (for example third form of energy) energy advantageously for the continuous supply of the building. For example, while the conversion of electrical energy to thermal energy is associated with very high levels of efficiency, storing very large amounts of electrical energy or heat can be problematic because such storage requires a lot of space or their investment amounts lead to uneconomical overall systems, whereas the conversion of electrical energy in chemical energy occurs with a somewhat poorer efficiency, but the storage of chemical energy (for example in the form of gas/fuel gas) offers the possibility to realize a higher energy density when storing chemical energy compared to electrical or thermal energy storage due to the compression. Depending on the extent of the excess or lack of energy or the demand for a specific form of energy, the system can be used advantageously.

The exemplary system can be advantageously further developed in that the first energy supply module has a first energy generator for generating an amount of energy of the first form of energy, the generated amount of energy of the first form of energy being dependent on at least a first, discontinuous energy source, in particular a renewable energy source such as solar energy and/or wind energy.

If the electrical energy (for example the first form of energy) is provided by renewable energies, the problem of the continuous energy supply to the building becomes even more complex and therefore even clearer. When it comes to generating electrical energy using renewable energies, photovoltaic systems on the roofs of buildings or on the associated property are particularly popular. Small wind turbine solutions (e.g. wind turbines, vertical wind turbines, etc.) are also available on the market today and are becoming increasingly popular.

A problem with these energy sources, especially energy from solar radiation (solar energy) and energy from air flow (wind energy), is availability. At night, when there is no sun, solar energy cannot be generated. The same thing happens when there is no wind, then no wind turbine can generate electrical energy for use. If both come together, it is a so-called “Dunkelflaute”.

Another problem is that there is often a lack of suitable consumers during the day, for example, when the sun is shining and can therefore be used to produce energy, especially in private households, as the majority of the population carries out an employment outside of their own home during the day and therefore the energy generated at home often cannot be fully used for one's own devices and aids (such as lighting, computing technology and printers, etc.). A comparable problem also exists with wind energy, which could in principle be produced at any time of the day or night, but only when the wind is blowing, and ideally the energy generated is also consumed at this time.

The exemplary system makes it possible for the amount of energy generated from discontinuous energy sources such as solar radiation (using photovoltaic or solar systems) or air flow (using wind turbines) to be made available day and night to supply a building.

The times of energy excess are used to fill the energy storage in order to compensate for the missing amount of energy in times of lower energy production by photovoltaic units and/or wind turbines, in particular times in which less energy is generated than is consumed by the building's consumers.

Even when using discontinuous energy sources such as solar energy and wind energy to provide electrical energy, the use of chemical energy as a form of compensation energy has proven to be very positive, as the fluctuations in the provision of electrical energy are also used very advantageously or could be balanced by the system already described above in order to ensure a continuous supply of electrical and thermal energy to the building.

The exemplary system can be advantageously further developed in that the first energy supply module has a third energy storage for storing an amount of energy of the first form of energy.

In particular, the control unit can control the modules of the system in such a way that, if the amount of energy of the first form of energy generated or provided by the first energy supply module is greater than the amount of energy of the first and second forms of energy consumed by the consumer module, substantially the excess amount of energy is delayed or simultaneously stored in the first energy storage for storing the second form of energy, in the second energy storage for storing the third form of energy and in the third energy storage for storing the first form of energy, and that, if the amount of energy of the first form of energy generated or provided by the first energy supply module is smaller than the amount of energy of the first and second forms of energy consumed by the consumer module, substantially the amount of energy stored in the first energy storage for storing the second form of energy, in the second energy storage for storing the third form of energy, after this has been converted into an amount of energy the first and/or the second form of energy, and in the third energy storage for storing the first form of energy is delayed or simultaneously released again for consumption in the consumer module.

The exemplary development makes it possible for energy quantities of the first form of energy (for example electrical energy) to be advantageously stored in order, for example, to store/buffer them at least briefly in the event of very high excesses of electrical energy, for example, and to use them for conversion into chemical energy, for example, for longer-term storage or, conversely, to store the additional electrical energy resulting from the conversion of chemical energy, for example into thermal energy, and to make it available again to the exemplary system on demand. Here too, the control unit can control the storage and discharging processes of the electrical storage device in accordance with the storage and discharging processes already described.

Not only the consumer module(s) of the building can be supplied with the stored and re-provided energy, but also the machines and systems as primary load-dependent heat generators as well as the technical units/modules of the building and thus the entire exemplary system itself.

The exemplary system can be advantageously further developed in that the first energy converter module has a fifth energy storage which is configured to convert an amount of energy of the second form of energy into an amount of energy of the third form of energy and to store it, wherein the fifth energy storage is configured to convert the stored amount of energy of the third form of energy back into an amount of energy of the second form of energy.

The fifth energy storage can advantageously convert the amount of energy of the second form of energy (for example thermal energy) directly into an amount of energy of the third form of energy (for example chemical energy) and prepare it for storage in the fifth energy storage. In addition, the fifth energy storage is configured to carry out this process reversibly, so that the stored amount of energy of the third form of energy is converted back into an amount of energy of the second form of energy and this (second form of energy) can be made available for feeding into the exemplary system by the fifth energy storage.

The fifth energy storage can advantageously be used in the system described, since, in addition to the excess of electrical energy, there can also be an excess of thermal energy in the exemplary system. For example, such a thermal excess can exist when the primary load-dependent heat generators are fully utilized and all other thermal storages are fully loaded, but less heat is consumed in the building's consumer modules than is generated, so that a chemical heat storage can be used advantageously here. A further example of the advantageous use of the chemical heat storage can be the storage of the heat energy generated by the third energy converter when the chemical energy stored in the third energy storage is reconverted.

The exemplary system can be advantageously further developed in that storing the excess amount of energy of the different forms of energy in the energy storages, releasing the amount of energy of the different forms of energy stored in the energy storages and converting the excess or released amount of energy of the different forms of energy are carried out in a sequence controlled by the control unit, wherein the control unit being configured to control the sequence depending on a primary load of the first, primary load-dependent energy converter and a demand of the consumer module for an amount of energy of the first form of energy and an amount of energy of the second form of energy.

In particular, the factor capacity utilization of the primary load of the first energy converter can be a relevant parameter for controlling the system, on the one hand to determine and thus “plan” the amount of thermal energy to be generated, but also to always keep the thermal energy that can be produced in line with the demand of the consumer module of the building and to initiate appropriate storage of the excess thermal energy, for example in the event of overproduction/overgeneration of thermal energy. The same applies, of course, to an excess of electrical energy, which can also be advantageously either stored directly or firstly converted into another form of energy, for example thermal and/or chemical energy, and stored accordingly.

But other parameters such as availability of storage capacity of the individual forms of energy or the short-term provision of comparatively large amounts of energy, for example large amounts of electrical energy, for example, for energy-intensive manufacturing processes, can also be advantageously taken into account when controlling the system.

The exemplary system can be advantageously further developed in that the first energy storage comprises a short-term storage for the short-term storage of the amount of energy of the second form of energy and a long-term storage for the medium-term to long-term storage of the amount of energy of the second form of energy.

In a particularly advantageous manner, it is advisable to provide a short-term storage (for example a so-called layered storage, a buffer storage or a heat buffer that are filled with water, for example) in combination with a long-term storage (for example a so-called seasonal storage) for storing the thermal energy. While even smaller amounts of thermal energy (for example, in addition to the thermal energy amounts of the primary load-dependent heat generators, also thermal energy amounts during the conversion of electrical energy into chemical energy and its reconversion in the second or third energy converter) are excellently stored in a short-term storage and can be released over a day up to a few days for use in the building, larger amounts of heat energy (such as the thermal energy amounts of the primary load-dependent heat generator) can be stored in a long-term storage for long-term storage and release of heat over several weeks to months. The amounts of heat in the short-term and long-term storage can be used not only for heating the building, but of course also for heating drinking water.

The exemplary system can be advantageously further developed in that the short-term storage and the long-term storage are in direct operative connection with one another, so that an amount of energy of the second form of energy can be exchanged between the short-term storage and the long-term storage.

By the direct operative connection, heat exchange can take place directly between the two storages and does not have to be fed into the heating network firstly, which leads to an easier transfer of heat quantities. The direct operative connection can be achieved, for example, by directly connecting the two storages (short-term storage and long-term storage) with water-carrying pipes or equivalents. Furthermore, heat exchange can also take place, for example, via a plate heat exchanger.

The exemplary system can be advantageously further developed in that the control unit is further configured to control the storage of the amount of energy of the second form of energy in the first energy storage so that primarily the amount of energy is stored in the short-term storage, and secondarily storage of the amount of energy of the second form of energy occur in the long-term storage.

As already described, it can make sense to initially store the amount of heat in the short-term storage (for example, to release it again over the rest of the day or night and heat the building or prepare the hot water), while, for example, excess heat can be stored in the long-term storage after the short-term storage has been filled or at least partially filled. However, other boundary conditions may also come into question in order to determine the order in which the amount of heat is stored.

The exemplary system can be advantageously further developed in that the second energy converter for converting the first form of energy into the third form of energy and the third energy converter for converting the third form of energy into the first form of energy of the second energy converter module is an assembly that is configured to carry out the process of the conversion of the third form of energy into the first form of energy as a reversible process of converting the first form of energy into the third form of energy.

This advantageous embodiment of the exemplary system allows the total number of individual components in the system to be kept somewhat tower, so that control of the components by the control unit is simplified. In particular, the exemplary system can be designed advantageously, if the conversion of the first form of energy into the third form of energy and the third form of energy into the first form of energy involves a direct or single-stage conversion of the original form of energy into the target form of energy.

The exemplary system can advantageously be further developed with a second energy supply module, which has a second energy generator for generating the third form of energy, the generation of an amount of energy of the third form of energy by the second energy generator being dependent on at least one second energy source that is different from the first energy source, wherein this second energy supply module further has a fourth energy converter for converting the third form of energy into the second form of energy.

The exemplary system can be advantageously expanded by an additional energy supply module, since in addition to the previous regenerative or renewable energy sources such as sun and wind, wood can now also be used as a renewable raw material. This second energy generator makes it possible to be switched on demand-based and thus initially support the system by generating gas as a third form of energy and then feed heat into the system by converting the chemical energy into thermal energy and, for example, to supply or to load the short-term storage and/or the long-term storage with heat quantities. Furthermore, the fifth energy storage can also be loaded with thermal energy. The advantage, for example, is that heat from the fifth storage (chemical heat storage) can be released demand-based, while the second energy generator, which is designed, for example, as a log gasifier, burns with its entire amount of wood and necessarily provides the energy completely over the course of a few hours.

The exemplary system can be advantageously further developed in that the second energy supply module has a fourth energy storage for storing the second form of energy, wherein the fourth energy storage for storing the second form of energy is in no or in direct operative connection with the first energy storage for storing the second form of energy for exchanging an amount of energy of the second form of energy.

In particular, it is of course advantageous if the second energy supply module also has its own energy storage for storing quantities of heat, which is optionally connected to the short-term storage and thereby quantities of heat can be transferred from the energy storage of the second energy supply module to the first energy storage.

The exemplary system can advantageously have an additional consumer that is different from the at least one consumer of the consumer module of the building for consuming an amount of energy of the second form of energy, wherein the control unit being configured to control the additional consumer in such a way that, if the energy storages used to store the second form of energy (for example the thermal short-term and long-term storage or the chemical heat storage) essentially no longer have any capacity for an additional amount of energy of the second form of energy, an excess amount of energy of the second form of energy (which, for example, is due to the capacity utilization of the primary load-dependent heat generator and/or the conversion from electrical to chemical energy and its reconversion) is supplied to the additional consumer for consumption in order to reduce the total amount of energy in the system, in particular the amount of energy of the second form of energy.

This additional consumer is able to remove large amounts of thermal energy (second form of energy) from the system if, for example, there is far too much thermal energy already in the system and a type of “emergency cooling” of the system is required and/or for example all storages are already fully loaded. For example, a heatable outdoor pool can be used for this purpose, which large amount of water is heated and the potential excess heat can be released into the surroundings.

The exemplary system can be advantageously further developed in that the first form of energy is electrical energy, the second form of energy is thermal energy, and the third form of energy is chemical energy.

The exemplary system is particularly suitable for the combined use of electrical, thermal and chemical energy. As already described, each form of energy has advantages and disadvantages in terms of production, conversion and storage. Depending on the situation or availability of energy sources (such as solar and wind energy or energy from renewable raw materials such as wood or plant materials in general) or on the energy requirements of the building (e.g. differences in the building's energy requirements between the summer season and winter season and/or demand by primary load-dependent heat generators such as servers/computing units, machine tools, packaging systems, etc.) it can be advantageous to prefer one form of energy over another.

The advantages of each individual form of energy in the exemplary system can be used to control energy management more efficiently and more demand oriented.

The exemplary system can be advantageously further developed in that the assembly is a reversible fuel cell, which in one process can convert an amount of electrical energy into an amount of chemical energy and can carry out this process in reverse, from chemical energy to electrical energy.

A reversible fuel cell can advantageously be provided as a component of the exemplary system, which can convert electrical energy into chemical energy (for example into fuel gas such as hydrogen, ammonia or methane) and is also able to carry out this process in reverse. This makes it possible to advantageously switch between the two forms of energy and, depending on the demand (for example the demand for a form of energy or the demand for special properties such as better storability, etc.), the (better) suitable form of energy can be selected and converted or reconverted accordingly.

The exemplary system can be advantageously further developed in that the system also has a connection to the public power grid, wherein the control unit is configured for allowing or stopping the supply of electrical energy from the public power grid into the system and for allowing or stopping the feeding of electrical energy from the system into the public power grid.

By connecting to the public power grid, in times when the system's own production of energy (such as by sun and wind, for example during the so-called “Dunkelflaute”) is not possible or is not sufficient and/or the storage of the exemplary system are substantially emptied, to an energy supply from outside of the system can be fell back. In addition, such a connection can also be used to feed additional amounts of energy into the system and, if necessary, store it, which can be particularly advantageous if, for example, the costs for the amounts of energy are comparatively cheap (for example, comparing prices for Night-time electricity with the prices for electricity during the day or when a particularly large amount of green electricity is available from wind and sun or when there is less demand for electricity).

The exemplary system is controlled by the control unit in such a way that the producers of electrical energy generate as much electricity at any time as the consumers of the electrical energy consume. Producers can be, for example, wind turbines/photovoltaic units. Consumers can be, for example, technical systems (such as the first, primary load-dependent energy converter or the second energy converter) and household electronics. Electrical storages (such as the third energy storage) can be regulated by their ability to both absorb electrical power and also release electrical power at a different time by means of control by the control unit for power absorption in the amount of the excess electrical power at that time and thus attributed to the consumers. At another moment with a deficit of electrical power, i.e. a higher consumption of electrical power/energy by the consumers in contrast to the electrical energy generated by the producers, the electrical storage can be regulated by means of control by the control unit for electrical power release to the level in which the deficit in electrical power exists. This means that in the exemplarily described second case the electrical storages can be attributed to the electrical generators. In both cases, the electrical power transmission to the public power grid is zero. The internal power grid continues to oscillate at 50 Hertz synchronously with the public power grid, but without power transmittance (also referred to as parallel operation).

The exemplary system can be advantageously further developed in that the system has a heat pump which increases the amount of thermal energy in the system by reversing the heat-power process, wherein the heat pump uses the thermal energy stored in the long-term storage of the first energy storage.

Using a heat pump as a further advantageous component of the exemplary system, the amount of energy (for example per liter of water or per cubic meter of air) can be further increased, since it reverses the heat-power process and increases the amount of heat through additional work performed, wherein the additional amount of heat can be advantageously supplied to the exemplary system and in particular advantageously supplied to the storage for the second form of energy. For example, the heat pump can use the electrical and thermal energies generated by converting chemical energy to further increase the amount of heat in the exemplary system.

The exemplary system can be advantageously further developed in that the long-term storage of the first energy storage is a seasonal heat storage, in particular an earth basin heat storage.

By using so-called seasonal heat storage, the amount of energy generated or converted into the second form of energy (heat) can be stored for a comparatively long time and made available to the consumer over this long time. It can be particularly advantageous to use an earth basin heat storage, since this can be arranged, for example, in the foundation of a building, so that an additional, larger space requirement in or in the immediate vicinity of the building is not necessary for this form of seasonal heat storage. Furthermore, a seasonal heat storage can also be formed as a geothermally effective terrestrial collector layered on several levels with hydraulic feed-in and withdrawal capability of thermal energy as well as top and side insulation.

The exemplary system can be advantageously further developed in that the first energy converter is a computing unit that carries out computer operations as a primary load and converts the primary load-dependent electrical energy into thermal energy by carrying out the computer operations.

A particularly advantageous embodiment of the exemplary system is that a computing unit such as a server structure or an entire data center is used to generate or convert heat (for example second form of energy) from electrical energy (for example first form of energy), which primary load are computer operations, but as a kind of secondary load, thermal energy is created from electrical energy, which can be made available to the system for use and in particular to supply the building.

Since these computing systems require a significant amount of electrical energy, which is primarily converted into heat by the computing processes themselves, it is advantageous to use this generated heat and, for example, to heat a building and/or use it to prepare hot water, instead of releasing it by a cooling system into the environment.

The use of computing units to generate heat is advantageous because digitalization in society will continue to advance and computing capacity will therefore continue to be needed in the future to cover the need for servers and storage space.

Other devices, such as machine tools, manufacturing plants, logistics systems, etc., which have correspondingly energy-intensive drives, hydraulic units and/or controls that also produce a lot of waste heat, can also be used as primary load-dependent energy converters for the primary load-dependent conversion of electrical energy into thermal energy.

The exemplary system can be advantageously further developed in that the second energy generator of the second energy supply module is a wood gasification boiler and the fourth energy converter is a wood gas burner, wherein the wood gasification boiler and wood gas burner being one assembly.

To provide additional energy, it may make sense to expand the exemplary system with a wood gasification boiler. This can gasify wood through an autothermal reaction and thereby generate combustible gas, which is used to generate heat in a wood gas burner associated with the wood gasification boiler. Wood is one of the renewable and therefore “green” and renewable raw materials for energy production, even if it produces climate-damaging CO₂ and fine dust compared to, for example, the operation of a wind turbine or a solar system.

Compared to other solid fuel boilers, today's modern wood gasification boilers with wood gas burners can achieve very low pollutant emission values and very high levels of efficiency thanks to automatically controlled combustion and electrical fine dust separators.

The exemplary system can be advantageously further developed in that the third energy storage for storing the electrical energy is a vanadium redox flow accumulator or a lithium-ion accumulator.

Different types of accumulators can advantageously be used for storing electrical energy (for example, the first form of energy), with vanadium redox flow accumulators having a significantly higher operational reliability compared to lithium-ion accumulators, since their electrolyte having a high water content is not flammable or explosive, so that vanadium redox flow accumulators can survive short circuits without damage. Vanadium redox flow accumulators also offer the advantage of being permanently stable, which, with regard to the electrolyte, theoretically allows an infinite number of charging cycles without reducing the charging capacity. However, other accumulators can also be used, for example other solid-state accumulators such as lithium iron phosphate (LiFePO₄) accumulators.

According to a further aspect, an exemplary method for controlling an aforementioned system for the continuous, demand-based energy supply of a building by means of a control unit is proposed, comprising: providing an amount of energy of a first form of energy by means of a first energy provision module, converting, in a primary-load dependent manner, a portion of the amount of energy of the first form of energy into a second form of energy being different from the first form of energy by means of a first primary load-dependent energy converter of a first energy converter module, consuming a demand-based amount of energy of the first form of energy and/or a demand-based amount of energy of the second form of energy by at least one consumer of a consumer module of the building, wherein, if the amount of energy provided by the first energy supply module of the first form of energy is greater than the demand-based amount of energy of the first and second forms of energy consumed by the consumer module, then storing the substantially excess amount of energy of the second form of energy delayed or simultaneously in a first energy storage of the first energy converter module, converting the substantially excess amount of energy of the first form of energy into a third form of energy being different from the first and second forms of energy by means of a second energy converter of a second energy converter module, wherein during the conversion of the substantially excess amount of energy of the first form of energy into the third form of energy, a part of the substantially excess amount of energy of the first form of energy is simultaneously converted into the second form of energy and supplied to the first energy storage for storage, and storing the amount of energy of the third form of energy in a second energy storage of the second energy converter module, and/or if the amount of energy of the first form of energy provided by the first energy supply module is smaller than the demand-based amount of energy of the first and the second form of energy consumed by the consumer module, then releasing the amount of energy stored in the first energy storage for storing the second form of energy for consumption in the consumer module, then releasing the amount of energy stored in the second energy storage for storing the third form of energy to a third energy converter, and converting the amount of energy released by the second energy storage for storing the third form of energy into an amount of energy of the first form of energy by means of the third energy converter for consumption in the consumer module, wherein, when converting the amount of energy of the third form of energy released by the second energy storage into the first form of energy, at the same time a part of the amount of energy of the third form of energy being released is converted into the second form of energy and fed to the consumer module for consumption.

The advantages already mentioned with regard to the exemplary system can of course equally apply to the exemplary method, so that they will not be repeated here.

The exemplary method can advantageously be further developed with generating an amount of energy of a first form of energy by means of a first energy generator of the first energy supply module, wherein the generated amount of energy of the first form of energy being dependent on at least a first, discontinuous energy source, in particular a renewable energy source such as solar energy and/or wind energy.

The exemplary method can be advantageously further developed in that, if the amount of energy of the first form of energy provided by the first energy supply module is greater than the amount of energy of the first and second forms of energy consumed by the consumer module, then a portion of the substantially excess amount of energy of the first form of energy is stored delayed or simultaneously in a third energy storage of the first energy supply module, storing the substantially excess amount of energy of the second form of energy in the first energy storage of the first energy converter module, converting another part of the substantially excess amount of energy of the first form of energy into the third form of energy by means of the second energy converter module, wherein when converting the other part of the substantially excess amount of energy of the first form of energy into the third form of energy, a part of the other part of the substantially excess amount of energy of the first form of energy is simultaneously converted into the second form of energy and fed to the first energy storage for storage, and storing the amount of energy of the third form of energy in the second energy storage of the second energy converter module, and/or, if the amount of energy of the first form of energy provided by the first energy supply module is smaller than the amount of energy of the first and second forms of energy consumed by the consumer module, then delayed or simultaneously releasing the amount of energy stored in the third energy storage for storing the first form of energy for consumption in the consumer module, releasing the amount of energy stored in the first energy storage for storing the second form of energy for consumption in the consumer module, releasing the amount of energy stored in the second energy storage for storing the third form of energy to the third energy converter, and converting the amount of energy released by the second energy storage device for storing the third form of energy into an amount of energy of the first form of energy by means of the third energy converter for consumption in the consumer module, wherein, when converting the amount of energy released by the second energy storage device of the third form of energy into the first form of energy, at the same time a part of the amount of energy of the third form of energy being released is converted into the second form of energy and fed to the consumer module for consumption.

The exemplary method can advantageously be further developed by storing the excess amount of energy of the different forms of energy in the energy storages, releasing the amount of energy of the different forms of energy stored in the energy storages and converting the excess or released amount of energy of the different forms of energy are carried out in a sequence controlled by a control unit, wherein the control unit is configured to control the sequence depending on a primary load of the first, primary load-dependent energy converter and a demand of the consumer module for an amount of energy of the first form of energy and an amount of energy of the second form of energy.

The exemplary method can be advantageously further developed in that the first energy storage comprises a short-term storage for the short-term storage of the amount of energy of the second form of energy and a long-term storage for the medium-term to long-term storage of the amount of energy of the second form of energy, wherein the control unit is further configured to control the storage of the amount of energy of the second form of energy in the first energy storage so that primarily the amount of energy is stored in the short-term storage, and secondarily the amount of energy of the second form of energy is stored in the long-term storage.

The exemplary method can advantageously be further developed with generating an amount of energy of the third form of energy by means of a second energy generator of a second energy supply module, wherein the generation of an amount of energy of the third form of energy by the second energy generator being dependent on at least one second energy source that is different from the first energy source, converting the generated amount of energy of the third form of energy into the second form of energy by means of a fourth energy converter of the second energy supply module, and storing the amount of energy of the second form of energy in a fourth energy storage of the second energy supply module, wherein the control unit is configured to generate, convert and store the amount of energy by the second energy supply module depending on the energy demand of the consumer module and the availability of the second energy source.

The exemplary method can advantageously be further developed with consuming an excess amount of energy of the second form of energy by an additional consumer that is different from the at least one consumer of the consumer module of the building, if the energy storage for storing the second form of energy substantially no longer has any capacity for an additional amount of energy of the second form of energy to reduce the total amount of energy in the system, especially the amount of energy of the second form of energy.

The exemplary method can be advantageously further developed in that the first form of energy is electrical energy, the second form of energy is thermal energy, and the third form of energy is chemical energy.

The exemplary method can advantageously be further developed with allowing or stopping the supply of electrical energy from the public power grid into the system by means of a connection of the system to the public power grid or allowing or stopping the feeding of electrical energy into the public power grid from the system by means of the connection of the system to the public power grid.

According to a further aspect, an exemplary control unit for controlling an aforementioned system for the continuous, demand-based energy supply of a building is proposed, wherein the control unit is configured to carry out a method for controlling the system for the continuous, demand-based energy supply of the building of the aforementioned type.

According to a further aspect, an exemplary computer program product is proposed with a computer program stored on a computer-readable data storage medium, which is executable on an aforementioned control unit or in a computer connected to a control unit and which is configured to control a method of the aforementioned type.

According to a further example, an exemplary system for the continuous energy supply of a building is proposed, with a first energy supply module which has a first energy generator for generating an amount of energy of a first form of energy, the generated amount of energy of the first form of energy being dependent on at least a first energy source, a first energy converter module, which has a first energy converter for converting a part of the amount of energy of the first form of energy into a second form of energy that is different from the first form of energy and a first energy storage for storing the amount of energy of the second form of energy, a second energy converter module that has a second energy converter for converting another part of the amount of energy of the first form of energy into a third form of energy being different from the first and the second form of energy, a second energy storage for storing the amount of energy of the third form of energy and a third energy converter for converting a stored amount of energy of the third form of energy into the first form of energy, a consumer module, which has at least one consumer of the building for consuming an amount of energy of the first form of energy and/or an amount of energy of the second form of energy, and a control unit for controlling the modules of the system, wherein the first energy source for generating the first form of energy is a discontinuous energy source.

In particular, the control unit can control the modules of the system in such a way that, if the amount of energy of the first form of energy generated or provided by the first energy supply module is greater than the amount of energy of the first and second forms of energy consumed by the consumer module, substantially the excess amount of energy is stored delayed or simultaneously in the first energy storage for storing the second form of energy and in the second energy storage for storing the third form of energy, and that, if the amount of energy of the first form of energy generated or provided by the first energy supply module is smaller than the amount of energy of the first and the second form of energy consumed by the consumer module, substantially the amount of energy stored in the first energy storage for storing the second form of energy and the amount of energy stored in the second energy storage for storing the third form of energy is released again delayed or simultaneously for consumption in the consumer module.

The exemplary system makes it possible to store a comparatively large amount of excessively produced electrical energy (for example through conversion or direct storage) and thereby avoid feeding this excess amount of energy into the public power grid, which in turn contributes to network stability. If the storage of the various forms of energy (such as electrical energy, thermal energy and chemical energy) are essentially fully utilized (fully charged), the system can release large amounts of energy into the environment via an additional consumer (such as a heated outdoor pool, etc.) and thus the excess amounts of energy are removed from the system without supplying the amount of energy to the public power grid and thus potentially contributing to instability of the public grid.

The control unit of the exemplary system can also advantageously control the storing and discharging processes of the energy storage in such a way that the storing process of the energy storage of the second form of energy (electrical energy) takes place simultaneously with the storing process of the energy storage of the third form of energy (chemical energy). Both delayed storage of the different forms of energy and storage one after the other are possible. The same applies to the discharging processes of the storage, which can also be timely controlled. Various conditions can be used as a criterion/dependency (for example due to different efficiencies of the individual forms of energy compared to the other form of energy when converting or the demand for a corresponding form of energy for consumption in the building, etc.) as to when which storage is loaded or discharged and how.

The exemplary system can advantageously be further developed in that the first energy supply module has a third energy storage for storing an amount of energy of the first form of energy.

In particular, the control unit can control the modules of the system in such a way that, if the amount of energy of the first form of energy generated or provided by the first energy supply module is greater than the amount of energy of the first and second forms of energy consumed by the consumer module, substantially the excess amount of energy is stored delayed or simultaneously in the first energy storage for storing the second form of energy, in the second energy storage for storing the third form of energy and in the third energy storage for storing the first form of energy, and that, if the amount of energy of the first form of energy generated or provided by the first energy supply module is smaller than the amount of energy of the first and the second forms of energy consumed by the consumer module, substantially the amount of energy stored in the first energy storage for storing the second form of energy, the amount of energy stored in the second energy storage for storing the third form of energy and the amount of energy stored in the third energy storage for storing the first form of energy, are released again delayed or simultaneously for consumption in the consumer module.

The exemplary system can be advantageously further developed by storing the excess amount of energy of the different forms of energy generated by the first energy supply module in the energy storages, releasing the amount of energy of the different forms of energy stored in the energy storages and converting the released amount of energy of the different forms of energy in a sequence controlled by the control unit, wherein the sequence is determined depending on an efficiency between the amount of energy generated, stored and converted, and wherein the higher efficiency has priority over the lower efficiency.

In particular, taking into account the different efficiencies for controlling when, how and into which other form of energy the produced or excess amount of energy (e.g. electrical energy, or one of the other two forms of energy) is converted, contributes to optimal use of the energy being generated by the discontinuous energy sources such as solar and wind.

While, for example, in the case of a comparatively very large excess of energy, it may make sense to convert the excess amount of energy with a lower level of efficiency but with a much larger storage capacity, in the case of a comparatively small excess of energy, it may be more useful to convert the excess amount of energy with the highest possible efficiency, but at the same time with smaller storage capacities.

In addition, parameters such as availability (for example, while the storage for chemical energy is already 80% loaded and the storage for electrical energy is only 20% loaded, the electrical storage preferably continues to be loaded, etc.) in terms of storage capacity of the individual forms of energy can be taken into account or upcoming changes in energy demands, for example in the warmer times (late spring to early autumn) of the year, less thermal energy (heat energy) is required than, for example, in the colder times of the year, so that, for example, from the end of summer of the respective year, the heat storage of the system should be loaded. This can also be decisive or additionally decisive for the control of the system and the processing of excess energy.

For further advantageous, exemplary further developments of the exemplary embodiment of the exemplary system, reference is made to the aforementioned further development examples of the exemplary system.

According to a further example, an exemplary method for controlling an aforementioned system for the continuous energy supply of a building by means of a control unit is proposed, the method comprising: generating an amount of energy of a first form of energy by means of a first energy generator of a first energy supply module, the amount of energy generated being dependent on the first form of energy of at least one first, discontinuous energy source, converting a part of the amount of energy of the first form of energy into a second form of energy that is different from the first form of energy by means of a first energy converter of a first energy converter module, consuming the amount of energy of the first form of energy and/or the amount of energy of the second form of energy by at least a consumer of the building of a consumer module, wherein, if the amount of energy of the first form of energy generated by the first energy supply module is greater than the amount of energy of the first and second forms of energy consumed by the consumer module, then storing the substantially excess amount of energy of the second form of energy delayed or simultaneously in a first energy storage of the first energy converter module, converting the substantially excess amount of energy of the first form of energy into a third form of energy that is different from the first and the second form of energy by means of a second energy converter of a second energy converter module, and storing the amount of energy of the third form of energy in a second energy storage of the second energy converter module, wherein, if the amount of energy of the first form of energy generated by the first energy supply module is smaller than the amount of energy of the first and second forms of energy consumed by the consumer module, then, in a delayed or simultaneous manner, release the amount of energy stored in the first energy storage for storing the second form of energy for consumption in the consumer module, releasing the amount of energy stored in the second energy storage for storing the third form of energy to a third energy converter, and converting the amount of energy released by the second energy storage for storing the third form of energy into an amount of energy of the first form of energy by means of the third energy converter for consumption in the consumer module.

The advantages already mentioned in relation to the example of the exemplary system can of course equally apply to the exemplary embodiment of the exemplary method, so that they will not be repeated here.

The exemplary method can comprise, if the amount of energy of the first form of energy generated by the first energy supply module is greater than the amount of energy of the first and second forms of energy consumed by the consumer module, in a delayed or simultaneous manner, storing a part of the substantially excess amount of energy of the first form of energy in a third energy storage of the first energy supply module, storing the substantially excess amount of energy of the second form of energy in the first energy storage of the first energy converter module, converting another part of the substantially excess amount of energy of the first form of energy into the third form of energy by means of the second energy converter of the second energy converter module, and storing the amount of energy of the third form of energy in a second energy storage of the second energy converter module, wherein the exemplary method can further comprise, if the amount of energy of the first form of energy generated by the first energy supply module is smaller than the amount of energy of the first and second forms of energy consumed by the consumer module, then, in a delayed or simultaneous manner, a release of the amount of energy stored in the third energy storage for storing the first form of energy for consumption in the consumer module, a release of the amount of energy stored in the first energy storage for storing the second form of energy for consumption in the consumer module, a release of the amount of energy in the second energy storage for storing the third form of energy to a third energy converter, and converting the amount of energy released by the second energy storage for storing the third form of energy into an amount of energy of the first form of energy by means of the third energy converter for consumption in the consumer module.

In the exemplary method, storing the excess amount of energy of the various forms of energy generated by the first energy supply module in the energy storages, releasing the amount of energy of the various forms of energy stored in the energy storages and converting the released amount of energy of the various forms of energy can occur in a sequence controlled by the control unit, wherein the sequence is determined, for example, depending on an efficiency between the amount of energy generated, stored and converted, and where the higher efficiency has priority over the lower efficiency. Alternatively or additionally, the sequence can be determined, for example, depending on a cost model between the amount of energy generated, stored and converted. The cost model is influenced by production costs, operating costs and efficiencies. Lower production and operating costs have priority over higher production and operating costs. The higher efficiency takes precedence over the lower efficiency.

In the exemplary method, the first energy storage can comprise a short-term storage for the short-term storage of the amount of energy of the second form of energy and a long-term storage for the medium-term to long-term storage of the amount of energy of the second form of energy, wherein the short-term storage and the long-term storage being in direct operative connection with one another, so that the control unit can control exchange of an amount of energy of the second form of energy between the short-term storage and the long-term storage.

In the exemplary method, the control unit can control the storage of the amount of energy of the second form of energy in the first energy storage so that primarily the amount of energy is stored in the short-term storage, and secondarily the amount of energy of the second form of energy is stored in the long-term storage.

The exemplary method can comprise generating an amount of energy of the third form of energy by means of a second energy generator of a second energy supply module, wherein the generation of an amount of energy of the third form of energy by the second energy generator is dependent on at least one second energy source that is different from the first energy source, converting the generated amount of energy of the third form of energy into the second form of energy by means of a fourth energy converter of the second energy supply module, and storing the amount of energy of the second form of energy in a fourth energy storage of the second energy supply module, wherein the control unit controls the generation, conversion and storage of the amount of energy by the second energy supply module depending on the energy demand of the system and the availability of the second energy source.

The exemplary method can comprise consuming an excess amount of energy of the second form of energy by an additional consumer that is different from the at least one consumer of the building of the consumer module to reduce the total amount of energy in the system, if the energy storage for storing the second form of energy substantially no longer has any capacity for an additional amount of energy of the second form of energy.

In the exemplary method, the first form of energy may be electrical energy, the second form of energy may be thermal energy, and the third form of energy may be chemical energy.

The exemplary method may comprise allowing or stopping the supply of electrical energy from the public power grid into the system by means of a connection of the system to the public power grid or allowing or stopping the supply of electrical energy to the public power grid from the system by means of the connection of the system to the public power grid.

According to a further example, an exemplary control unit for controlling an aforementioned system for continuous supply of energy to a building is proposed, wherein the control unit is further configured to carry out an aforementioned method for controlling the aforementioned system for continuous supply of energy to the building.

According to a further example, an exemplary computer program product is proposed with a computer program stored on a computer-readable data storage medium, which is executable on an aforementioned control unit or in a computer connected to a control unit and which is configured to control an aforementioned method.

Further aspects and their advantages as well as advantages and more specific implementation options of the aspects and features described above are described in the following, but in no way restrictive, descriptions and explanations of the attached figures.

### BRIEF DESCRIPTION OF THE DRAWINGS

FIG. 1 shows an overview of the systematic classification of the exemplary system in the supply structure of a building or the systems and machines of a building and the energy suppliers,

FIG. 2 shows an exemplary embodiment of the exemplary system for the continuous, demand-based energy supply of a building using a first, primary load-dependent energy converter of a first energy converter module,

FIG. 3 shows an exploded view of an exemplary building with an outbuilding with implementation of the exemplary system,

FIG. 4a shows a diagram of heat absorption and heat emission of the modules of the exemplary system in kW, calculated as an example in a model calculation, over a time range of the first quarter of a year (here the year 2022 as an example), starting from January,

FIG. 4b shows the continuation of the diagram from FIG. 4a over a time range of the second quarter of the exemplary year, starting from April,

FIG. 4c shows the continuation of the diagram from FIG. 4b over a time range of the third quarter of the exemplary year, starting from July,

FIG. 4d shows the continuation of the diagram from FIG. 4c over a time range of the fourth quarter of the exemplary year, starting from October,

FIG. 5a shows a diagram of a charging power and extraction power of the second energy storage device of the exemplary system, which is formed as a hydrogen storage device, in kW over the time range of a year (here, for example, the year 2022), calculated as an example in the model calculation,

FIG. 5b shows a diagram of a load level of the second energy storage (for example, hydrogen storage) of the exemplary system in % over the time range of a year (here, for example, the year 2022), which is calculated as an example in the model calculation.

FIG. 6a shows a diagram of a charging power and extraction power of the third energy storage device of the exemplary system, which is formed as a vanadium redox flow accumulator, in kW over the time range of a year (here, for example, the year 2022), calculated as an example in the model calculation,

FIG. 6b shows a diagram of a load level of the third energy storage device (for example, vanadium redox flow accumulator) of the exemplary system in % over the time range of a year (here, for example, the year 2022), which is calculated as an example in the model calculation,

FIG. 7a shows a diagram of a charging power and extraction power of the long-term thermal storage of the exemplary system in kW over the time range of a year (here, for example, the year 2022), which is calculated as an example in the model calculation,

FIG. 7b shows a diagram of a load level of the long-term thermal storage (formed as an earth-coupled heat storage) of the exemplary system in % over the time range of a year (here, for example, the year 2022), which is calculated as an example in the model calculation,

FIG. 8a shows an exemplary method for controlling an exemplary system for the continuous, demand-based energy supply of a building using the control unit,

FIG. 8b shows an exemplary method for controlling an exemplary system for the continuous, demand-based energy supply of a building by means of the control unit, which can be used in addition to or as an alternative to the exemplary method as shown and described in FIG. 8a.

### DETAILED DESCRIPTION OF THE DRAWINGS AND PREFERRED EMBODIMENTS

In the following, examples or embodiments of the present disclosure are described in detail with reference to the accompanying drawings. The same or similar elements in the drawings can be designated with the same reference signs, but sometimes also with different reference signs.

It should be emphasized that the subject-matter of the present disclosure is in no way limited to the exemplary embodiments described below and their embodiment features, but further includes modifications of the exemplary embodiments, in particular those that are achieved by modifying the features of the examples described or by combination of one or more of the features of the described examples are included within the scope of protection of the independent claims.

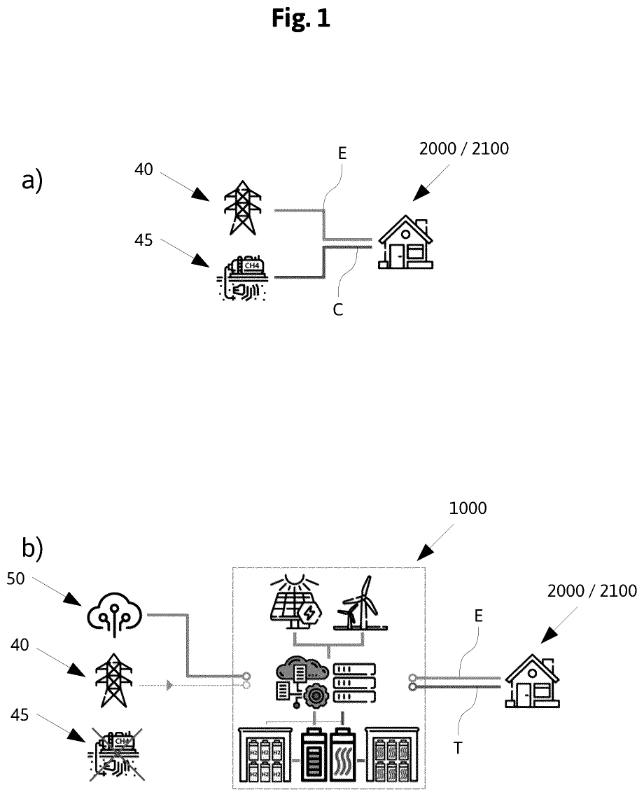

FIG. 1 shows an overview of the systematic classification of the exemplary system 1000 in the supply structure of a building 2000/2100 or the systems and machines of a building 2000/2100 and the energy suppliers 40/45.

Illustration a) shows in general terms how the building 2000/2100 as a consumer is essentially connected to the supply of electrical energy E from a power supplier (public power grid 40) and, for example, to the supply of chemical energy C from, for example, a natural gas supplier 45.

The exemplary system 1000 is, as shown in illustration b), connected between the energy suppliers 40/45 and the building 2000/2100 as a consumer.

If there is a demand for a primary load (represented here as a demand for computing capacity 50), a primary load-dependent energy converter such as a computing unit or a data center in the exemplary system 1000 can be used to generate the heat in the building 2000/2100 (through consumption/conversion of electrical energy E into thermal energy T through computer processes), wherein, for example, the supply of the building 2000/2100 with natural gas by a natural gas supplier 45 can be omitted (typically natural gas is used for heating the building 2000/2100, in some cases also for cooking in building 2000/2100). In addition, the burning of fossil fuels can be largely avoided.

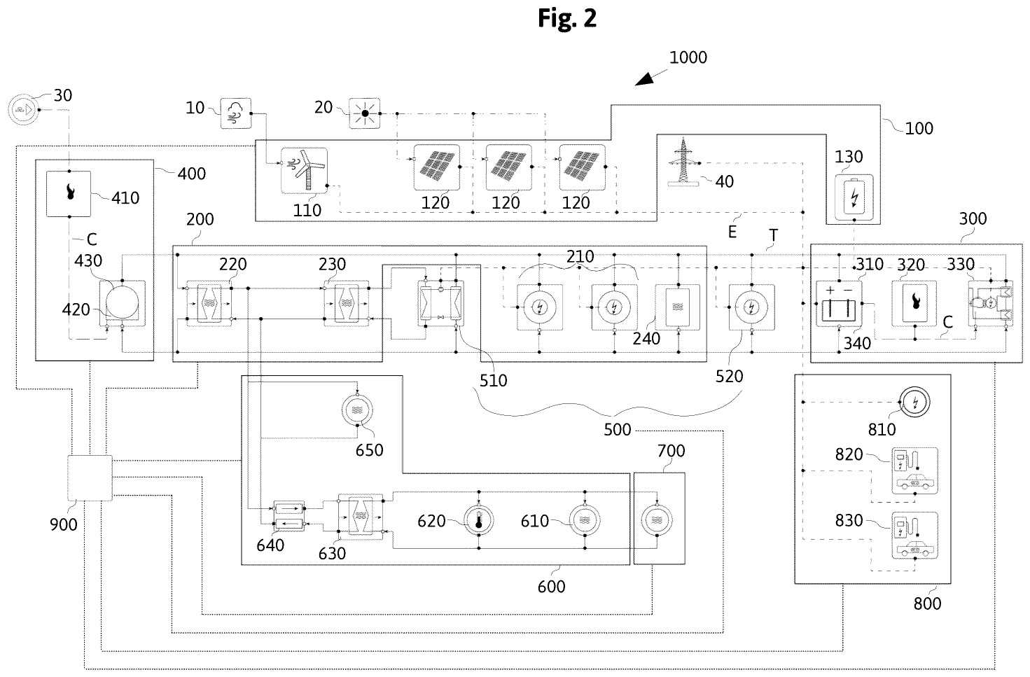

However, since the primary load dependency can, for example, lead to a fluctuation in the generation of heat for the building 2000/2100, it is advantageous to take measures to ensure a continuous energy supply to the building 2000/2100 with electrical energy E as well as with thermal energy T. For this purpose, the exemplary system 1000 is explained in more detail below in FIG. 2.

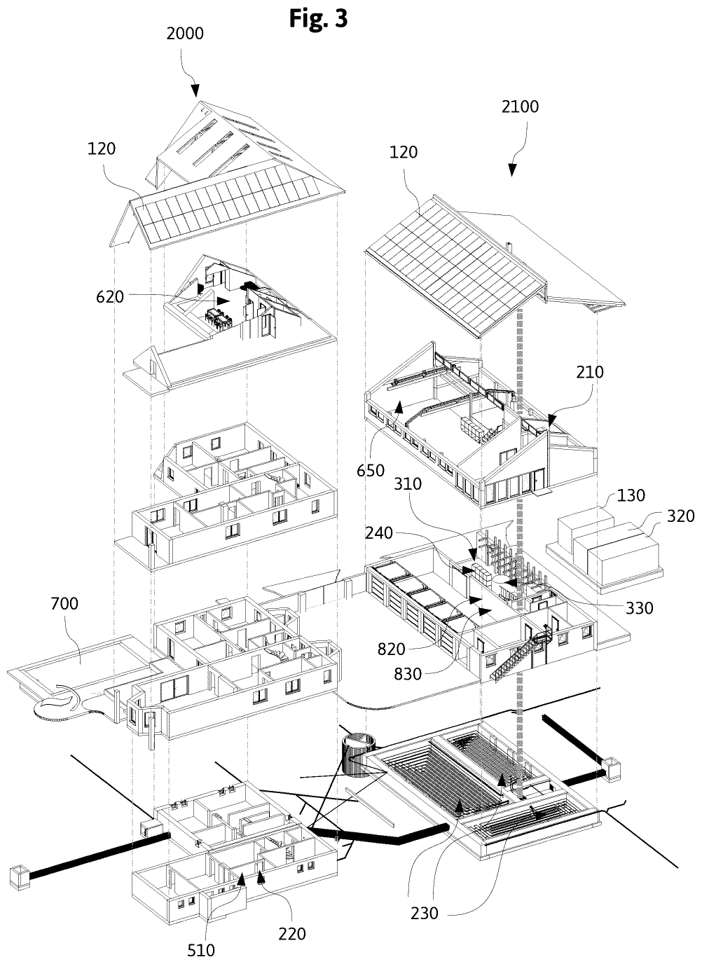

FIG. 2 shows an exemplary embodiment of the exemplary system 1000 for the continuous, demand-based energy supply of a building 2000 (for a more detailed view of the building, see FIG. 3) using a first, primary load-dependent energy converter 210 of a first energy converter module 200.

Within the present technical teaching, the primary load is understood to be the value-adding activity of a device (machine, facility, system, etc.), such as the machining of a component by a machine tool, the execution of computer operations and/or storage processes in a computing unit, etc.

Depending on the amount/load of the value-adding activity (amount of the primary load), these devices convert at least some of the form of energy (first, second, third form of energy) required for added value into another form of energy (first, second, third form of energy). For example, part of an electrical energy E (for example, first form of energy), which the device requires, for example, to machine a workpiece or to carry out computer operations, can be converted, for example, into thermal energy T (for example, second form of energy). This amount of energy converted into heat (thermal energy T) could be advantageously used for other purposes (such as heating private and/or office buildings, heating agricultural facilities such as barn, etc.).

Often, such production processes or the use of servers/computing units are subject to corresponding, sometimes large, fluctuations. For example, the machine tool, which is not machining a component due to maintenance/setup, cannot generate any usable waste heat or the computing unit can hardly be used to generate waste heat, if it is less used.

This form of generation/conversion of the thermal energy T is therefore subject to fluctuations in the utilization/the extent of the primary load of the devices, so that a continuous supply of the buildings/facilities with thermal energy T can hardly be guaranteed.

In the following, the interaction of various components, sometimes also differently formed components (units, modules) of the exemplary system 1000 will be explained using the exemplary system 1000, wherein further positive effects will be explained depending on the combination and expansion of the exemplary system 1000.

If electrical energy E (for example first form of energy) is provided, this electrical energy E or at least part of this electrical energy E (or the amount of energy of the electrical energy E) can be advantageously converted, for example, into thermal energy T (for example second form of energy) by the first, primary load-dependent energy converter 210 of the first energy converter module 200. In particular, a high level of efficiency, comparable to the high levels of efficiency in power-to-heat systems, can initially be advantageous over other conversions (for example power-to-gas).

For this purpose, it can be particularly advantageous, if, for example, in the first energy converter module 200 there is a computing unit 210/a computing center 210 as the first energy converter 210, which carries out computer operations and/or storage processes using the provided electrical energy E, to convert a part or a large part of the electrical energy E into thermal energy T and to make it usable for the system 1000, for example, by feeding the thermal energy T into the heat supply of the building 2000, which was otherwise usually given off as waste heat to the environment or to the environment via cooling systems.

In this way, on the one hand, the electrical energy E supplied into the exemplary system 1000 can be converted very effectively into thermal energy T and, at the same time, computing capacity and storage capacity can be provided by means of a computing unit 210/a data center 210, which become increasingly important and will therefore be in demand in the next few years or decades in the course of the digitalization of society and a wide variety of processes.

The computing unit 210/the data center 210 can be designed, for example, as a server structure with worldwide access options and/or can be used as an intranet, for example within large companies/groups, thereby providing benefit for the companies.

In addition, other devices such as machine tools or large systems (such as packaging systems, sorting systems, etc.) can also be used as first energy converters 210, since these devices often have a large number of drives and/or hydraulic units, some of which need to be cooled. Another example is the friction of the tool of a machine tool when machining a workpiece, which also generates heat, which is often carried away from the workpiece with a so-called cooling lubricant. Chemical systems that, for example, “incidentally” generate heat during the chemical conversion of substances can also be used as the first energy converters 210.

But not only the generation of heat (conversion of electrical energy E or chemical energy C into thermal energy T) can be an advantageous component of the exemplary system 1000, the storage of the thermal energy T (or the amount of thermal energy) can also be advantageous in a variety of ways be considered.

For example, it may be advantageous to provide a short-term storage 220 (or diurnal storage) as the first energy storage 220/230 for the short-term storage (for example several hours to a few days) of the thermal energy T, in particular to provided amounts of thermal energy T being required during the day and overnight in the consumer module 600 (thermal consumer module 600) of the building 2000, which can also be, depending on demands, very susceptible to fluctuations in the amount of energy per unit of time, and to react short-term to an increased demand or, conversely, to a lower demand.

For example, so-called buffer storages 220 (for example in the form of a layered storage with layered storage of thermal energy depending on the temperature level) can prove to be extremely advantageous, as they are comparatively limited in their amount of storable thermal energy T and are therefore exhausted quite quickly, but at the same time again can be quickly loaded with thermal energy T and in a comparatively short time. As a result, the fluctuations that occur in the consumption of thermal energy T in the consumer module 600 of the building 2000 over the day/over the night can be advantageously addressed.

Another component of a system 1000 can also be a storage of thermal energy T, which can store a comparatively very large amount of thermal energy T in the medium-term (several days to several weeks) or long-term (several weeks to several months) and partially can provide the amount of heat required in the building 2000 to the consumer module 600 over a long period of time (sometimes over several months).

Such thermal storages of the first energy storage 220/230, also referred to as seasonal storage 230/long-term storage 230 (or seasonal heat storage or seasonal storage), can be formed, for example, as a container heat storage, earth basin heat storage, geothermal probe heat storage or as an aquifer heat storage and have advantages and disadvantages depending on demands and geological environmental conditions or initial infrastructural conditions.

In addition, it can be advantageous, for example, if the short-term storage 220 and the long-term storage 230 of the first energy storage 220/230 have a direct connection/operative connection for exchanging amounts of heat, so that, for example, the amount of heat (or parts thereof) long-term stored in the long-term storage 230 can be made available to the short-term storage 220 via a short and therefore quick path, if, for example, the amount of thermal energy T provided or converted by the exemplary data center 210 can no longer cover the consumption of thermal energy T of the building 2000.

In addition, an exchange of heat (for example from short-term storage 220 to long-term storage 230) can advantageously take place via a heat exchanger, wherein the temperature level would be reduced. Conversely, by means of a heat pump (see for example heat pump 510) and the supply of electrical energy E (as an exemplary first form of energy), it can be shifted from the long-term storage 230 back into the short-term storage 220 with an increase in the temperature level.

Another advantageous component of the exemplary system 1000, in particular of the first energy converter module 200, can be a fifth energy storage 240, which is formed as a thermochemical heat storage 240. Excess heat can, for example, be bound in an endothermic chemical reaction using silica gels, metal hydrides, zeolites or metal oxides in an oily suspension, such as hygroscopic oxides such as boron oxide (conversion of thermal energy T into storable chemical energy C) and without loss over long periods of time as chemical energy C stored. When required, heat (thermal energy T) is released via a controlled exothermic chemical reaction (conversion of stored chemical energy C to thermal energy T) and is available for use in the building 2000 or the outbuilding 2100. The reaction products of the exothermic reaction correspond to the reaction starting materials of the endothermic reaction, so that overall a reversible process for the storage and release of thermal energy is created.

In addition, for example, the long-term storage 230 can also be formed as a thermochemical storage 240 (fifth energy storage 240) in order, for example, to store thermal energy T in a space-saving manner compared to an earth basin heat storage.

Since not every building has a seasonal storage 230/long-term storage 230 for long-term storage of thermal energy T and/or some of the longer-term heat storages are not loaded, it can be extremely advantageous to provide an additional module in the exemplary system 1000 for the continuous, demand-based energy supply of the building 2000.

For this purpose, a second energy converter module 300 can be an advantageous component, wherein the second energy converter module 300, in contrast to the first energy converter module 200, can convert the electrical energy E into chemical energy C (for example third form of energy) (power-to-gas) and is also able to convert the chemical energy C back into electrical energy E and/or thermal energy T.

In particular, the second energy converter module 300 can have, for example, a second energy converter 310, for example an electrolysis unit 310, which converts electrical energy E into chemical energy C through a redox reaction with water (water electrolysis) to generate thermal energy T, wherein in the water electrolysis the water is split into oxygen (O₂) and hydrogen (Ha). The latter of the two can advantageously be used, for example, for a conversion, for example in a third energy converter 330 (for example combined heat and power plant 330, which burns the hydrogen H₂, or fuel cell 330, which converts the hydrogen H₂ into electricity by supplying oxygen O₂, with waste heat being generated in both cases) in order to generate demand-based electrical energy E (electricity) and/or thermal energy T (heat) for the consumer module 600 (thermal consumer module 600) and/or for the consumer module 800 (electrical consumer module 800) of the building 2000.

In addition, it may be advantageous if the second energy converter module 300 has a second energy storage 320 for storing the chemical energy C (such as hydrogen H₂) that was formed/generated in the second energy converter 310 (for example in the electrolysis unit 310). An advantage of this energy storage method is that a comparatively large amount of energy can be stored in a comparatively small space, since gaseous substances in particular as carriers of chemical energy E (e.g. hydrogen) are very highly compressible and storable under appropriate pressure. This means that storage for large amounts of chemical energy C can be advantageously provided in or on a building even when space is relatively small.

Furthermore, the second energy converter 310 and the third energy converter 330 can be designed as an assembly 340, in particular as a reversible fuel cell 340, which can convert an energy amount of electrical energy E into an energy amount of chemical energy C in a process, wherein the chemical energy C can be stored in the second energy storage 320, and can carry out this process in reverse, from chemical energy C to electrical energy E.

In both processes (from electrical energy E to chemical energy C and from chemical energy C to electrical energy E), additional thermal energy T is generated, which, like the resulting thermal energy T in the electrolysis unit 310 and/or in the fuel cell 330/in the combined heat and power plant 330, can be stored in the first energy storage 220/230 of the first energy converter module 200.

By using the reversible fuel cell 340 as a second energy converter 310, in addition to the advantageous reduction in the number of individual components within the exemplary system 1000, it is also possible to effectively temporarily store excess amounts of energy, for example generated by the wind turbine 110 or by the photovoltaic unit 120, in the second energy storage 320 (for example as gas bottles or, due to the lower pressure of 30 to 40 bar, as a large-volume plastic tank or comparable; furthermore, in addition to gaseous storage, the chemical bonding of H₂ in ammonia as a liquid can also take place, for example if pressures of at least 9 bar can be applied in the storage process). In particular, the operator of the exemplary system 1000 can be provided with an additional option of storing the excess energy as chemical energy C, in addition to storing the excess amount of energy as thermal energy T in the corresponding short-term storage 220 or long-term storage 230, wherein aspects such as the efficiency of the respective conversion of electrical energy E into thermal energy T or into chemical energy C and/or the demand for thermal and/or electrical energy T/E could be taken again into account.

Advantageous reversible fuel cells 310 can be, for example, polymer electrolyte fuel cells (PEM) or solid oxide fuel cells (SOFC), the latter of which can partially achieve a power-to-power efficiency of up to 70%. Since this efficiency is significantly lower than in power-to-heat applications, the use of power-to-gas can be particularly advantageous if there is a significant excess of electrical energy E in the exemplary system 1000 and the heat storage devices 220, 230, for example are already very well or completely loaded or the heat storage devices 220/230 are too small or not available, so that the power-to-gas system can be used as a supplement or alternative to the heat storage devices 220, 230.

Through the exemplary combination of a first, primary load-dependent energy converter 210 (for example in the form of a machine tool, a computing unit, etc.) for converting electrical energy E into thermal energy T, the storage options for thermal energy T through short-term storage 220 and long-term storage 230, the conversion option of electrical energy E into chemical energy C through a second energy converter 310 (for example as an electrolysis unit 310) and corresponding storage options (second energy storage 320 for storing chemical energy C) as well as the possibility of converting chemical energy C into electrical energy E and/or thermal energy T, both electrical energy E and thermal energy T are advantageously made available to the consumer modules 600, 800 (thermal consumer module 600/electrical consumer module 800) of the building 2000 in a continuous and demand-based manner.

It can pose an additional challenge if only discontinuous energy sources such as wind 10 and solar radiation 20 are to be used or are available to provide electrical energy E.

Discontinuous energy sources such as wind 10 and solar radiation 20 can have very different strengths depending on the weather, time of day or night, season and location (e.g. equator or poles as extreme examples) or, for example, fail completely or be unavailable. The energy supply based on these discontinuous energy sources 10, 20 in the exemplary system 1000 can therefore be as maximum as possible (for example in summer, cloud-free and at midday, when the solar radiation 20 is strongest and, for example, a correspondingly strong wind 10 is blowing at the same time) up to complete collapse (for example at night and when there is absolutely no wind, also referred to as “Dunkelflaute”).

Since discontinuous energy sources 10, 20 are very dependent on circumstances and cannot provide continuous energy (a continuous amount of energy), it may be appropriate to use a corresponding exemplary system 1000. With the help of this exemplary system 1000, various forms of energy, for example electrical energy E, for example as a first form of energy, thermal energy T, for example as a second form of energy, and chemical energy C, for example as a third form of energy, as well as their possibilities for storage and conversion into the respective other forms of energy can be used to recharge the storage options when the energy supply from the discontinuous energy sources 10, 20 is excessed in relation to the energy consumption in the building 2000 or to consume the stored amount of energy when the energy supply has a deficit by the discontinuous energy sources 10, 20 in relation to the energy consumption of the building 2000.

In contrast, there are continuous energy sources for the exemplary system 1000 such as the public power grid 40, which are essentially a wide variety of classic energy sources for the production of electrical energy, starting from the combustion of fossil fuels such as coal or gas, the use of hydropower (for example pumped storage power plants) or nuclear energy.

Depending on which of these classic energy sources is being considered, some energy sources are easier to control (in the sense of switching on and off) and some not so or have to run continuously (e.g. coal-fired power plants). All of these various continuous energy sources feed the public power grid 40 and also contribute to its maintenance or stability.

For example, by means of a first energy supply module 100, electrical energy E (first form of energy) can be provided as a continuous energy source through the public power grid 40, as well as discontinuous energy sources such as wind 10 and/or solar radiation 20, which can be converted into electrical energy E, for example, by means of a wind turbine 110 and/or a photovoltaic unit 120 of the first energy supply module 100, and supplied for further use to the first energy converter module 200, the second energy converter module 300 and/or the electrical consumer module 800 of the building 2000.

In particular, when electrical energy E is exclusively provided by the discontinuous energy sources such as wind 10 and/or solar radiation 20 using the wind turbine 110 or the photovoltaic unit 120, it can be advantageous to store the electrical energy E in a third energy storage 130 of the first energy supply module 100. For example, the third energy storage 130 can be formed as a vanadium redox flow accumulator or as a lithium-ion accumulator or lithium iron phosphate accumulator.

Different types of accumulators can advantageously be used for storing electrical energy E (first form of energy), wherein vanadium redox flow accumulators having a significantly higher operational reliability compared to lithium-ion accumulators, since their electrolyte is neither flammable nor explosive because of a higher water content, meaning that vanadium redox flow accumulators can survive short circuits without damage. In addition, a vanadium redox flow accumulator is permanently stable compared to a lithium-ion accumulator. A lithium iron phosphate accumulator has a higher cycle stability than the lithium-ion accumulator, but does not achieve the long-term stability of the vanadium redox flow accumulator.

It has proven to be advantageous that, even in the case of a discontinuous provision of electrical energy E through the discontinuous energy sources wind 10 and solar radiation 20, with the exemplary system 1000 through the advantageous combination with the second energy converter module 300 (power-to-gas system), fluctuations in the provision of electrical energy E can be bridged.

As already described, if there is an excess of electrical energy E (it is provided a larger amount of energy E by the wind turbine 110 and/or photovoltaic unit 120 based on the discontinuous energy sources wind 10 and solar radiation 20 than the total amount of electrical energy and thermal energy is consumed by the consumer modules 600, 800 of the building 2000), the excess electrical energy E is either stored directly in the third energy storage 130 and/or converted into storable gas by, for example, the electrolysis unit 310/reversible fuel cell 310.

Only when there is a deficit of electrical energy E (a smaller amount of electrical energy E is provided by the wind turbine 110 and/or photovoltaic unit 120 based on the discontinuous energy sources wind 10 and solar radiation 20 than the total amount of electrical and thermal energy by the consumer modules 600, 800 of the building 2000 is consumed), it can be reverted to the stored forms of energy such as electrical energy E (for example stored in the third energy storage 130) or chemical energy C (for example stored in the second energy storage 320 and then for conversion into electrical energy E to the third energy converter 330 like a combined heat and power plant 330 or a reversible fuel cell 310) to supply the building 2000 with electrical energy E continuously and demand-based.

Furthermore, the exemplary system 1000 can comprise a second energy supply module 400, which generates chemical energy C based on a second energy source 30 by means of a second energy generator 410. The second energy source 30 can in particular be biomass 30 as a renewable raw material. For example, wood 30 in the form of logs, pellets, etc. is particularly suitable for this. However, other types of biomass (for example other plant components) can also be used for the production of chemical energy C (for example by fermentation of biomass such as plant components to produce biogas, in particular methane CHA). The chemical energy C generated can, for example, be stored again, for example in corresponding storages comparable to the second energy storages 320 of the second energy converter module 300.

Furthermore, the second energy supply module 400 can comprise a fourth energy converter 420, which converts the chemical energy C generated by the second energy generator 410 into thermal energy T. For this purpose, it can be advantageous if the chemical energy C is converted into thermal energy T by combustion and made available to the exemplary system 1000 for use, for example in the form of heating the hot water circuit/hot water network of the building 2000, and further if the thermal energy T (at least partially) can be used to generate the chemical energy C in the second energy generator 410.

For example, wood gasification boilers can advantageously be used for this purpose, in which the wood gasification by the second energy generator 410 (wood gasifier 410) takes place spatially separated from the wood gas combustion by the fourth energy converter 420 (wood gas burner 420), but the wood gasification boiler (comprising second energy generator 410 and fourth energy converter 420) is essentially one assembly.

Furthermore, the second energy supply module 400 can comprise a fourth energy storage 430 for storing the thermal energy T (for example second form of energy), wherein the fourth energy storage 430 can, for example, be in no or direct operative connection with the first energy storage 220/230 for storing the thermal energy T in order, for example, to be able to exchange an amount of thermal energy T with one another.

Another example aspect of the example system 1000 may be additional heat-generating devices. In particular in view of the fact that, for example, the computing unit 210/the computing center 210 only generates heat in a corresponding amount if correspondingly extensive computing and/or storage operations are carried out by the computing unit 210/the computing center 210 (primary load-dependent conversion of electrical energy E into thermal Energy T), the required amount of heat cannot potentially be generated at all times.

It can be advantageous if the exemplary system 1000 has a heat pump 510 of an additional heating module 500, which increases the amount of thermal energy T in the system 1000 by reversing the heat-power process, in which additional electrical energy E may also be required. In addition, it can be advantageous if the heat pump 510 uses the thermal energy T stored in the long-term storage 230 of the first energy storage 220/230, further increases this amount of thermal energy through the reverse heat-power process and then feeds it into the system 1000.

An additional contribution of heat in the exemplary system 1000 can, for example, be made by a heat cartridge 520 (or a modulating instantaneous water heater 520) of the additional heating module 500 in the exemplary system 1000, which generates thermal energy T by means of supplied electrical energy E (power-to-heat). In particular in the case of an excess of electrical energy E with at the same time low utilization of the computing unit 210/the data center 210 (or another device such as a machine tool, sorting system, etc.) and/or almost fully charged electrical storage 130 or electrical 130 or chemical storage 320 being already at maximum electrical wattage, the use of the heat cartridge 520/the modulating instantaneous water heater 520 can be useful for additional wattage and thus provide support in the provision of thermal energy T for the building 2000.

The building itself can, for example, comprise several consumers 610, 620, 650 in the consumer module 600, wherein, for example, some consumers 610, 620 can be provided inside the building 2000 and some consumers 650 can be provided outside the building 2000 or in an outbuilding 2100 of the building.

For example, the consumer module 600 (thermal consumer module 600) of the building can comprise a drinking water consumer 610 with heated water and also one or more radiators 620 (or surface heating systems 620; see below) for heating the room air of the building 2000 as a consumer for thermal energy T. The provision of drinking water (including heated drinking water) and the heating of the air in the building 2000 are usually basic requirements for every residential or office building.

In addition, the building 2000 can have a heat network 640 that is separate from the generation of the thermal energy T and the transport of the thermal energy T from the place of generation or from the place of storage to the place of consumption, wherein this heat network 640 can interact, for example, with a heat exchanger 630 or as jointly connected hydraulic system for exchanging thermal energy T for use by the consumers 610, 620.

In addition, the building 2000 can have an outbuilding 2100 (e.g. a workshop, a barn, a stable, etc.) which has at least one or more radiators 650 or surface heating systems 650 (such as underfloor heating, wall panel heating or ceiling heating) for heating the room air of the outbuilding 2100. The difference here lies particularly in the flow temperature that the respective heating systems require. For example, a 650 radiator usually requires a flow temperature of around 55° C. while a panel heating system 650 usually only needs a flow temperature of 35° C.

Another exemplary aspect of the exemplary system 1000 may be an outdoor pool 700, whose heat demands are also supplied from the building's heat network 640. The special features of such an outdoor pool 700 (additional consumer 700) can be its large amount of water and its exchange with the outside air at appropriate ambient temperatures. Both result in a large power loss from evaporative cooling (depending on the size of the water surface of the outdoor pool 700) and heat loss to the environment (depending on the outside temperature).

In particular, the outdoor pool, in addition to its capacity as a place of entertainment for people, can also represent a technically advantageous component in the exemplary system 1000. This is particularly the case when a very large amount of thermal energy T is already present in the exemplary system 1000, for example when all thermal storages 220/230 are already loaded, and the generation of additional heat by the first, primary load-dependent energy converters 210 cannot be reduced, since the value-adding activity (primary load) of the first energy converter module 200 (for example, in the case of a machine tool, machining a workpiece or in the case of a computing unit/server, carrying out computing operations or storage processes) is currently carried out, for example, at full load.

Then it can be extremely advantageous to be able to remove thermal energy T from the exemplary system 1000. Here, the large amount of water in the outdoor pool 700 (additional consumer 700) can play an advantageous role, since correspondingly large amounts of thermal energy T are “consumed” for the (additional) heating of this pool and can thus be withdrawn from the exemplary system 1000.

The heat exchange of the outdoor pool 700 with the outside air can also be advantageous, so that not only the (additional) heating of the outdoor pool 700 already removes large amounts of thermal energy T from the exemplary system 1000, but also continuously large amounts of thermal energy T from the exemplary System 1000 can be released into the outside air.

In this way, for example, the outdoor pool 700 (additional consumer 700) enables a type of emergency cooling of the exemplary system 1000, but this only occurs, for example, if another use or storage of the thermal energy T in the exemplary system 1000 is not possible.

The same can of course also happen if, for example, there is too much electrical energy E in the exemplary system 1000, the first energy converter module 200 with the first, primary load-dependent energy converter 210 cannot convert electrical energy E into thermal energy T, and a conscious release of this electrical energy E from the exemplary system 1000 is desired.

Then the electrical energy E can be converted into chemical energy C by conversion, for example by the second energy converter module 300, thereby already generating thermal energy T, which can be supplied to the outdoor pool 700. Furthermore, the chemical energy C can then be, beside the storage in the second energy storage 320, converted, in particular, into thermal energy T (for example in the third energy converter 330 or combined heat and power plant 330) and supplied to the outdoor pool 700 for release into the outside air. Alternatively or additionally, electrical energy E can of course also be released from the exemplary system 1000, for example by the heat pump 510 and/or by the heat cartridge 520, and converted into thermal energy T, which can again be released into the outside air/ambient air via the outdoor pool 700.

In addition, the additional provision of electrical energy E can also be reduced or completely shut down by appropriate control of the provision of electrical energy E by wind turbine 110, photovoltaic unit 120 or the public power grid 40 using a corresponding control unit 900 of the exemplary system 1000. The exemplary system 1000 is controlled in such a way that the electrical generators (for example wind turbine 110/photovoltaic unit 120) generate as much electricity at any time as the consumers of electrical energy E consume, wherein in particular electrical storage devices (such as the third energy storage device 130) have the ability to function both as electrical consumers (when they absorb electrical energy E and thus reduce the current amount of electrical energy E in the exemplary system 1000) and as electrical producers (when releasing the stored electrical energy E), so that the amount of power can be modulated by the controller in such a way that, for example, on a SMART meter with digital counting and digital HAN interface to the exemplary system 1000, no power is transferred from the public power grid 40 or into the public power grid 40.

The electrical consumer module 800 of the building 2000 can also contribute to the extraction of electrical energy E from the exemplary system 1000. On the one hand, the completely normal electricity demands 810 of the building 2000 and/or the outbuilding 2100 (for example operating a refrigerator, lighting, operating computer technology, etc.) can be used as consumers of electrical energy E, but also additional facilities 820, 830 such as, for example, corresponding charging stations/wall boxes 820, 830 for charging electrically powered vehicles such as electric cars, electric scooters and/or e-scooters can, as consumers of electrical energy E, significantly reduce the amount of electrical energy E in the exemplary system 1000.

In addition, the control unit 900 for controlling the modules (for example first energy supply module 100, first energy converter module 200, second energy converter module 300, second energy supply module 400, additional heating module 500, thermal consumer module 600, outdoor pool 700, electrical consumer module 800) can be advantageous for the exemplary system 1000.

It can be advantageous, for example, that the storage of the excess amount of energy of the various forms of energy (first, second, third forms of energy such as electrical, thermal, chemical energy) in the respective energy storages (first energy storage 220/230, second energy storage 320, third energy storage 130, fourth energy storage 430, fifth energy storage 240), the release of the amount of energy of the different forms of energy stored in the energy storage and the conversion of the excess or released amount of energy of the different forms of energy occurs in a sequence controlled by the control unit 900.

In addition, the control unit 900 can, for example, be configured to determine the order depending on the value-adding activity of the devices (primary load of the first, primary load-dependent energy converter 210) and/or a demand of the consumer module 600, 800 for an amount of energy of the first form of energy (for example electrical form of energy E) and an amount of energy of the second form of energy (for example thermal energy T).

Alternatively or additionally, for example, the different efficiencies in the conversion from one form of energy to another form of energy can be taken into account by the control unit 900 and the sequence or the conversion, storage and generation behavior of the respective forms of energy of the exemplary system 1000 can be changed/controlled accordingly, wherein, for example, the higher efficiency has priority over the lower efficiency.

In particular, taking into account the different efficiencies when controlling when, how and into which other form of energy the produced or excess amount of energy (e.g. electrical energy or one of the other two forms of energy) is converted contributes to the optimal use of the energy provided and the continuous and demand-based supply of the building 2000.

White, for example, in the case of a comparatively very large excess of energy, it may make sense to convert the excess amount of energy with a lower level of efficiency but with a much larger storage capacity, it could be more useful, in the case of a comparatively small excess of energy, to convert the excess amount of energy with the highest possible efficiency, but at the same time with smaller storage capacities.

Alternatively or in addition to this, a cost model between the amount of energy generated, stored and converted can also be used to determine the sequence by the control unit 900. The cost model is influenced by production costs, operating costs and efficiencies. Lower production and operating costs have priority over higher production and operating costs. The higher efficiency takes precedence over the lower efficiency.

Furthermore, the control unit 900 can, for example, be configured to control the storage of the amount of energy of the second form of energy (for example thermal energy T) in the first energy storage 220/230 so that primarily the amount of energy is stored in the short-term storage 220 and secondary the amount of energy of the second form of energy is stored in the long-term storage 230.

In addition, for example, the control unit 900 can be configured to control the outdoor pool 700 (additional consumer 700) in such a way that if the energy storage devices for storing the second form of energy (for example thermal energy T) essentially no longer have any capacity for an additional amount of energy of the second form of energy, an excess amount of energy of the second form of energy is supplied to the outdoor pool 700 (additional consumer 700) for consumption in order to reduce the total amount of energy in the exemplary system 1000, in particular the amount of energy of the second form of energy.

As a result, if necessary, a type of “emergency cooling” of the exemplary system 1000 can be carried out and the total amount of energy in the system 1000, for example, can be significantly reduced.

Furthermore, the control unit 900 can be configured, for example, for allowing or stopping the supply of electrical energy E from the public power grid 40 into the exemplary system 1000 for providing electrical energy E and/or for allowing or stopping the supply of electrical energy E from the exemplary system 1000 in the public power grid 40, for example in the event of an excess of self-produced electrical energy E (for example by the wind turbine 110 and/or the photovoltaic unit 120).

Particularly with regard to feeding electrical energy E into the public power grid 40, care can advantageously be taken not to endanger the so-called grid stability.

For example, if all photovoltaic systems in Germany fed into the public power grid 40 in addition to all the classic energy sources, there would be a far too high amount of electrical energy E in the grid, which in the worst case would lead to the collapse of the power grid, the so-called black-out.

But even much smaller amounts of energy can pose a problem for the public grid, so that, for example, when setting up new photovoltaic systems, there is a requirement that these systems must be able to be reduced remotely by the network operator from a peak output of 100 KW if there is a potential grid overload or grid instability.

It should be noted at this point that in the exemplary system 1000, electrical energy E was selected as the first form of energy, thermal energy T was selected as the second form of energy, and chemical energy C was selected as the third form of energy. The system 1000 described here is in no way limited to this, rather the first form of energy can also be one of the other two energies (thermal or chemical), the second form of energy can also be one of the other two energies (electrical or chemical), and the third form of energy can also be one of the other two energies (electrical or thermal).

It should also be noted at this point that for the respective energy transfer (transfer of electrical energy E, of thermal energy T, of chemical energy C) from one module and/or converter and/or storage to another module and/or other converter and/or other storage and/or other consumer respectively configured lines (E, T, C) are provided in the exemplary system 1000. Various current-transporting lines/materials such as lines made of steel, aluminum, copper, etc. can be used to transmit electrical energy E. For the energy transfer of thermal energy T, fluid-carrying lines (for example pipes), for example water, brine or air-carrying lines, can be used. Brine-carrying lines can include, for example, aqueous solutions of salts or refrigerants, such as halogenated hydrocarbons or glycols, both from plant production and from fossil petroleum, as well as other fluids for heat transfer. For the energy transfer of chemical energy C, for example, fluid-carrying lines (for example pipes) or containers (for example tanks) can also be used, which are configured to carry hydrogen and/or methane or suspensions of silica gels, metal hydrides, zeolites or metal oxides, such as boron oxide in oily suspension.

FIG. 3 shows an exploded view of an exemplary building 2000 with outbuilding 2100 with implementation of the exemplary system 1000.

For example, on the roof of the building 2000 and/or its outbuilding 2100, photovoltaic units 120 are used to provide electrical energy E, which can be stored, for example, in the third energy storage device 130, which is exemplarity formed here as a vanadium redox flow accumulator, and which can be used for consumption in the building 2000 or in the outbuilding 2100. For example, the third energy storage device 130 can be built on a separate foundation with some distance from the outbuilding 2100 (see right side of FIG. 3).

The electrical energy E provided by the photovoltaic units 120 or released by the third energy storage device 130 can advantageously be converted into thermal energy T in the first, primary load-dependent energy converter 210. Shown as an example is a server unit/computer unit with corresponding server racks that have water cooling, wherein the heated water, depending on the utilization of the computing unit, can be used, for example, for heating the building 2000 or the outbuilding 2100 within the exemplary system 1000. The computing unit can be provided as the first, primary load-dependent energy converter 210, for example on the first floor of the outbuilding 2100. The computing unit can of course also be provided at any other location in building 2000 or in the outbuilding 2100. It would be advantageous to create a structurally suitable room or installation location with thermal, acoustic and electromagnetic insulation.

Furthermore, in the outbuilding 2100, for example, the second energy converter 310 is provided for converting electrical energy E into chemical energy C, in order, for example, to carry out a corresponding conversion and subsequent storage of the chemical energy C in one of the second energy storage devices 320 in the event of excess electrical energy E. If electrical and/or thermal energy E/T is required, the stored chemical energy C can be retrieved again and electrical and/or thermal energy E/T can be produced by appropriate conversion or reconversion, for example in a fuel cell 330 or a combined heat and power plant 330 and can be provided for consumption in the building 2000 or in the outbuilding 2100.

In addition, the exemplary building 2000 or outbuilding 2100 can also use a heat pump 510 to provide additional thermal energy in the exemplary system 1000, wherein advantageously the heat pump 510 can be arranged spatially in the vicinity of the short-term thermal storage 220 and/or the long-term thermal storage 230.

The generated heat (thermal energy T) can be stored, for example, in thermal short-term storage 220 for the short-term re-provision of this energy, or also in thermal long-term storage 230, such as a seasonal heat storage, for long-term re-provision. This seasonal heat storage (thermal long-term storage 230) can be provided, for example, by means of brine pipes laid in loops between strip foundations of the outbuilding 2100 and release its heat (thermal energy T) into the material surrounding it for long-term storage.

In addition, a fifth energy storage device 240 formed as a thermochemical heat storage device 240 can be provided in the building 2000 or in the outbuilding 2100 to store the amount of heat generated long-term. The long-term thermal storage 230 can also be formed as a thermochemical heat storage 240 if, for example, the space in or on the building 2000 or outbuilding 2100 does not allow “classic” long-term thermal storage 230 such as an earth basin heat storage or a container heat storage. If the amount of heat in the exemplary system 1000 is too large and all thermal or thermochemical storage is already loaded and a type of emergency cooling is required in order to reduce the total amount of energy (in particular total thermal energy) from the exemplary system 1000, an outdoor pool 700 can be provided as an exemplary additional thermal consumer 700. By heating the outdoor pool 700 with the amount of heat in the system 1000, the large heat loss from evaporation cooling, which depends on the size of the water surface, and the heat losses to the environment, which depend on the outside temperature, the overall amount of heat in the exemplary System 1000 can be significantly reduced.

In addition to the typical consumers such as radiators and/or surface heating systems 620 of the building 2000 and radiators and/or surface heating systems 650 of the outbuilding 2100 of the thermal consumer module 600 and the general electrical consumers/power demands 810 of the building 2000 or the outbuilding 2100 of the electrical consumer module 800, charging stations/wall boxes 820, 830 may also be provided for charging electrically powered vehicles with electrical energy E in the exemplary building 2000 or outbuilding 2100, for example, in particular in an exemplary garage.

It should be noted at this point that the exemplary building 2000 or outbuilding 2100 shown here and described as an example can also comprise further modules or parts of modules of the exemplary system 1000 described in FIG. 2, for example a second energy supply module 400, which is formed as a wood gasification boiler (comprising second energy generator 410 and fourth energy converter 420).

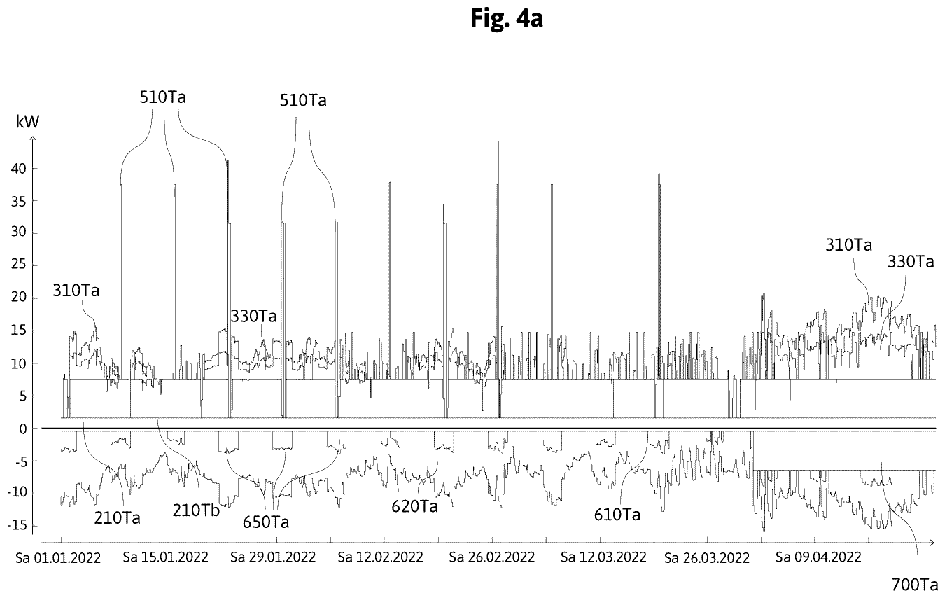

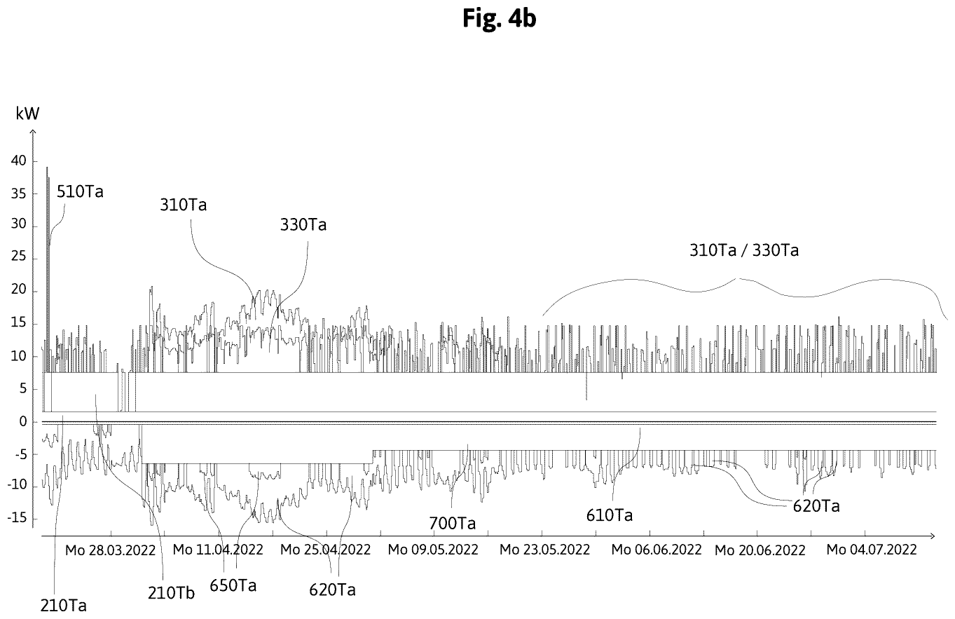

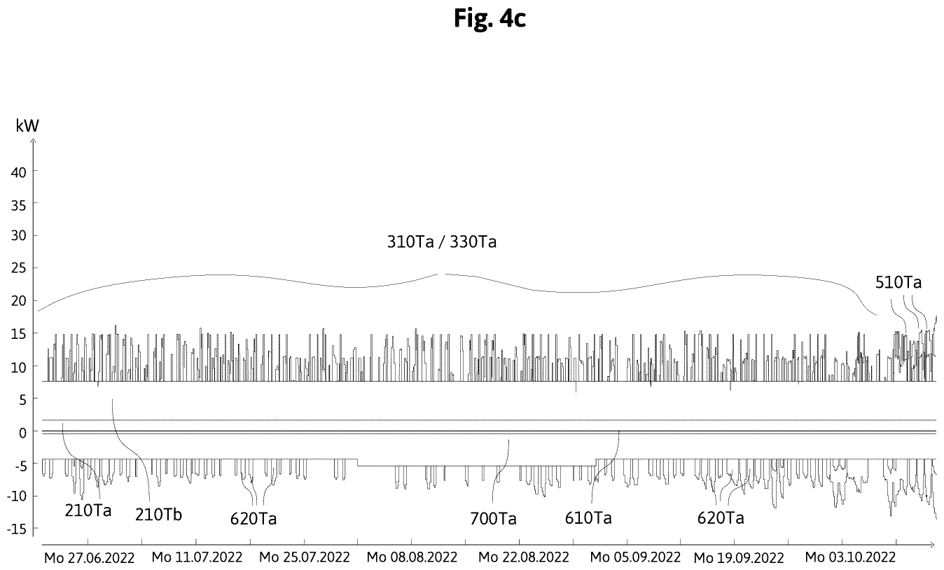

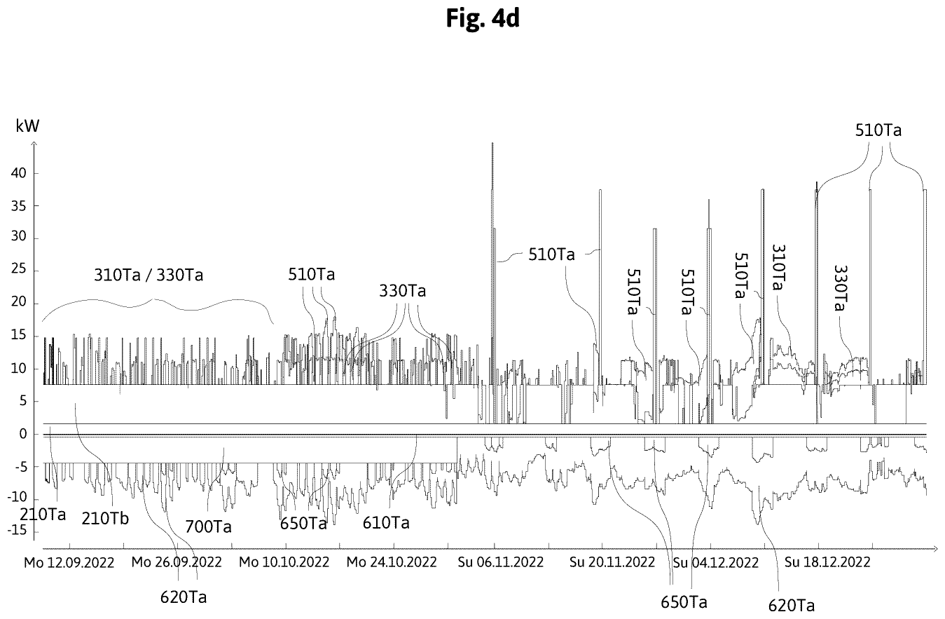

FIGS. 4a to 7b described below, which each show diagrams, deal with the topic of the energy balances of chemical, electrical and thermal energy C, E, T, particularly with regard to generation, consumption and storage by the respective modules or units, wherein the diagrams show the energies as the area under the respective curve (integral) as power P in kW (y-axis) over a period of time t (x-axis).

FIG. 4a shows a diagram of heat absorption (values in the negative area of the power axis represent the consumption of heat) and heat emission (values in the positive area of the power axis represent heat generation), calculated as an example in a model calculation, of the modules 200, 300, 500, 600, 700 of the exemplary system 1000 in kW over a time range of the first quarter of a year (here the year 2022 as an example), starting from January.

It can be seen that the heat output of the first, primary load-dependent energy converter 210, which is formed here as a server for example, has two heat quantities 210Ta, 210Tb. The server has a heat quantity 210Ta due to a base server load and a load-dependent heat quantity 210Tb due to a specific load on the server due to computing and/or storage processes. It can also be seen that the base load of the server emits a continuous amount of heat 210Ta over the quarter, while the load-dependent amount of heat 210Tb shows individual smaller fluctuations (for example due to isolated, significantly low server utilization).

These fluctuations are, for example, compensated for by the amount of heat 510Ta released by the used heat pump 510, which uses the amount of heat stored in the seasonal storage 230/long-term thermal storage 230 over the course of the previous year, in order to provide the amount of heat required in the exemplary system 1000.

In addition to the amounts of heat that the first, primary load dependent energy converter 210 emits, a quantity of heat 310Ta released by the electrolysis unit 310 can be seen in the diagram according to FIG. 4a as well as a released quantity of heat 330Ta of the fuel cell 330. These both released heat quantities 310Ta, 330Ta occur more often in the first quarter of the year, especially at the beginning of the year, and then decrease towards March.

In contrast to that, there are absorbed heat quantities 620Ta and 650Ta of the heating systems (for example radiators and/or surface heating systems 620, 650 of the building 2000/2100) for heating the building 2000/2100 and a constantly absorbed heat quantity 610Ta for the continuous provision of hot water.

However, the sum of the released and absorbed amounts of heat in a time range (e.g. a day) results in a relative balance, so that, for example, only with an exceptionally large production of electrical energy E (see, for example, on Jan. 22, 2022 on the time axis of the diagram in FIG. 4a caused by strong winds on a sunny day in the model calculation and the resulting large yields from wind and solar energy) large amounts of heat 310Ta are generated by the conversion using the electrolysis unit 310. If this is accompanied by low outside temperatures and thus a demand for heating, it can also happen directly that electricity and heat have to be provided again for the exemplary system 1000 by means of the fuel cell 330, especially when it is cloudy or at night and when the wind decreases, to cover the demand for electrical energy and heat (absorbed heat) for heating the building 2000/2100 and for hot water preparation.

The time period from April, in which an amount of heat 700Ta absorbed by the outdoor pool 700 is also shown, is described below.

FIG. 4b shows the continuation of the diagram from FIG. 4a over a time range of the second quarter of the exemplary year, starting from April.

Because there will be sufficient thermal energy available over the summer and the heating season for the building 2000/2100 ends, the thermal energy E can be accommodated already in April of the year to generate a comparatively large amount of heat 700Ta for heating and maintaining the desired temperature of the outdoor pool 700. Helpful for this is the available electrical energy E in the model calculation based on weather data from the exemplary location (Thuringia, Thuringian Basin region), which is converted in the electrolysis unit 310 due to excess in the exemplary system 1000 and, thus, be available for generation of the released amount of heat 310Ta. Since the days in April are still relatively short compared to summer, solar yields are only available for a limited time, so that the hydrogen storage 320 is discharged again overnight in order to make electrical energy E available for the technical systems. The fuel cell 330 thus provides an amount of heat 330Ta to generate the required electrical power, which also contributes to the required amount of heat 700Ta.

In the coming months, when the outside temperatures are warmer, less heat (700Ta) will have to be absorbed by the outdoor pool in order to maintain the temperature. This means that the server base load and the primary load of the server (emitted heat quantities 210Ta, 210Tb) as well as the short-term use of the electrolysis unit 310 and the fuel cell 330 (emitted heat quantities 310Ta, 330Ta), sometimes at different times, are used in order to provide coverage of the absorbed heat quantities 610Ta, 620Ta, 650Ta and 700Ta of the consumers and to load the long-term thermal storage 230/seasonal heat storage 230 with amounts of heat, which can later be used for the months that are colder in relation to the outside temperature by feeding it in via a heat pump 510.

FIG. 4c shows the continuation of the diagram from FIG. 4b over a time range of the third quarter of the exemplary year, starting from July.

What is particularly noticeable is that in August the amount of heat 700Ta absorbed by the outdoor pool 700 is increased, although no significantly increased amount of heat was released by the heat generators (such as server 210, electrolysis unit 310 or fuel cell 330). This may be due, for example, to the fact that the amount of energy in the exemplary system 1000 was too high and the outdoor pool 700 was used for targeted, additional energy consumption in order to reduce the total amount of energy in the exemplary system 1000. This can be made possible, for example, with additional heating of the outdoor pool 700. Depending on the heat generation and heat consumption, it may also be the case that an increase in the amount of heat 700Ta absorbed by the outdoor pool 700 is not necessary and the outdoor pool 700 can be heated more or less with a constant amount of heat absorption.

This may also be necessary if the seasonal storage 230/thermal long-term storage 230 is fully loaded from the end of July and can no longer absorb any additional amount of heat, so that the excess amount of heat has to be released into the environment via the outdoor pool 700.

FIG. 4d shows the continuation of the diagram from FIG. 4c over a time range of the fourth quarter of the exemplary year, starting from October.

From October onwards, a slight increase in the absorbed amount of heat 620Ta and 650Ta for heating the building 2000/2100 can be seen, although this is substantially related to the colder outside temperatures that occur at the end of each year, at least in the countries in the northern hemisphere, wherein as time progresses towards the winter months of December to February, the outside temperatures continue to fall and the heat absorption 620Ta and 650Ta increases significantly.

As can be seen in FIG. 4d, the amount of heat from the seasonal storage 230/long-term thermal storage 230 is also increasingly used, which is fed into the exemplary system 1000 as the amount of heat 510Ta released via the heat pump 510 and is used by the respective consumers 610, 620, 650 and 700, although the outdoor pool 700 is still heated in October.

The heating of the outdoor pool 700 can therefore still be seen in October in the present model calculation, as the generation of electrical energy from renewable energy sources (such as wind 10 or solar energy 20) is already declining significantly in October, so that more and more electricity is being generated from hydrogen. However, even more heat is released than was consumed by the entire system 1000 in October because the outside temperatures are not yet so cold that heating the building 2000/2100 would result in a corresponding consumption of thermal energy. Therefore, in this model calculation it is necessary to continue heating the outdoor pool 700 so that the entire system does not overheat.

In a system 1000 that would rely on continuously available temperature measurements under real conditions, the outdoor pool 700 would only be heated as long as there was a real excess of heat in the exemplary system 1000. Only when the excess heat would no longer exist or a lack of heat would occur in the system 1000, the exemplary system 1000 would switch on the heat pump 510 to generate additional amounts of thermal energy 510Ta.

It is only in November that the heat demand exceeds the heat production, so that heating the outdoor pool 700 can be waived. Additional heat demand is increasingly provided via the heat pump 510 and the thermal energy in the seasonal storage 230 is thus reduced.

If, as shown by way of example in the diagram in FIG. 4d, there would be a significant reduction in the utilization of the server, an amount of heat could be released from the seasonal storage 230/long-term thermal storage 230 in the short term using the heat pump 510 in order to transfer a correspondingly large amount of heat 510Ta into the exemplary System 1000 and to compensate for the “loss” of heat generation due to the lack of server utilization.

In addition, towards the end of the year, increased amounts of heat 310Ta and 330Ta from the electrolysis unit 310 and the fuel cell 330 can be used to provide heat for the building 2000/2100.

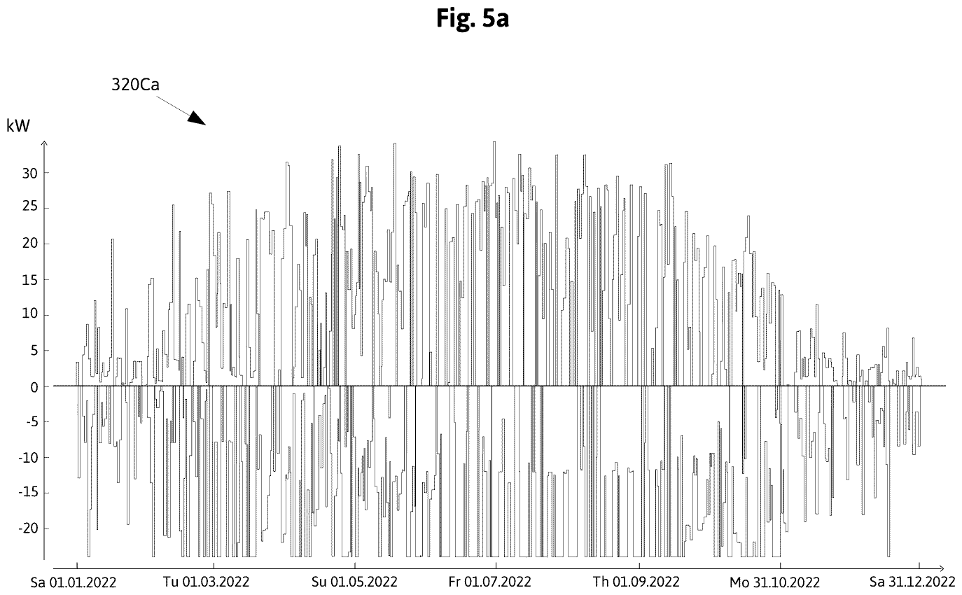

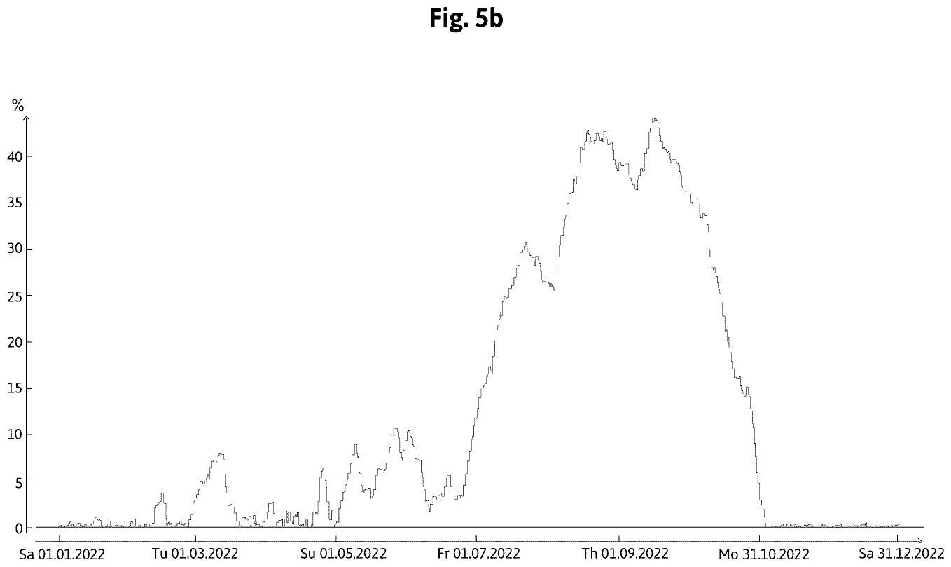

FIG. 5a shows a diagram of a loading power (values in the positive area of the power axis represent the absorption of chemical energy C) and extraction power (values in the negative area of the power axis represent the release of chemical energy C), calculated as an example in the model calculation, of the second energy storage 320 of the exemplary system 1000, formed as hydrogen storage 320, in kW over the time range of a year (here the year 2022 as an example).

In particular, in the first two months (January and February) and in the last two months (November and December) of the year, a reduced loading and extraction power of the chemical energy quantity 320Ca of the second energy storage 320 is apparent.

This reduced loading and extraction power of the chemical energy quantity 320Ca occurs particularly in the colder months of the year, which is due to the fact that, particularly in the warmer and therefore more sun-intensive months, significantly higher excess electrical energy E is generated by renewable energy sources, in particular by solar energy 20 or the photovoltaic unit 120, which was converted for advantageous storage into chemical energy C, for example by means of the electrolysis unit 310, and was fed to the second storage 320 for storage. In addition, cheaper electricity available from the public grid 40 can also be used to load the second energy storage 320.

In total, this partially caused storage power or loading power of the second energy storage 320 of over 30 kW and an increase in the load level of the second storage 320, especially from July onwards (see also FIG. 5b), since during this period the peak power output was constantly high (sometimes up to 24 KW) of the amount of chemical energy 320Ca from the second energy storage 320, which is still significantly below the loading power mentioned. The constantly high extraction performance can be due, for example, to the fact that the conversion of the chemical energy C into thermal energy T by the fuel cell 330 was additionally used to heat the outdoor pool 700 during this period.

Only from approximately September onwards is the loading power below the extraction power of the second energy storage 320, which thus leads to a reduction in the load level of the second energy storage 320 from September onwards (see also FIG. 5b). The reduced loading power in this period may be due, for example, to the fact that the electrical energy E must be used increasingly for the additional provision/generation of thermal energy T for heating the building 2000/2100 (see also FIG. 4d, approx. from September), for example by operating the servers/value-adding machines as primary load-dependent heat generators (first, primary load-dependent energy converter 210) and systems or by switching on the heat pump 510.

From November of the year, there was also a significantly reduced extraction rate of chemical energy 320Ca, which may be due to the fact that there is less electricity from renewable energies, for example, so that less chemical energy C (here hydrogen) is generated in the electrolyzer 210 and is stored in the second energy storage 320. Because of that, the storage 320 often becomes empty (without absorption of electricity from the public power grid) (see also FIG. 5b, from November). Only if the storage 320 is not empty electricity can be made available on a demand-based manner with using waste heat.

FIG. 5b shows a diagram of a loading level of the second energy storage 320 (exemplary hydrogen storage 320) of the exemplary system 1000 in % over the time range of a year (here the year 2022 as an example), which is calculated in the model calculation.

As already partially mentioned in FIG. 5a, a significant increase of the loading level of the second storage 320 (hydrogen storage 320) occurs from July, because, as also shown in FIG. 5a, the loading power regularly exceeds the extraction power of the second storage 320.

From approximately September onwards, the loading power is below the extraction power of the second energy storage 320, which therefore leads to a sometimes significant reduction in the load level of the second energy storage 320 within a short period of time (see also FIG. 5a).

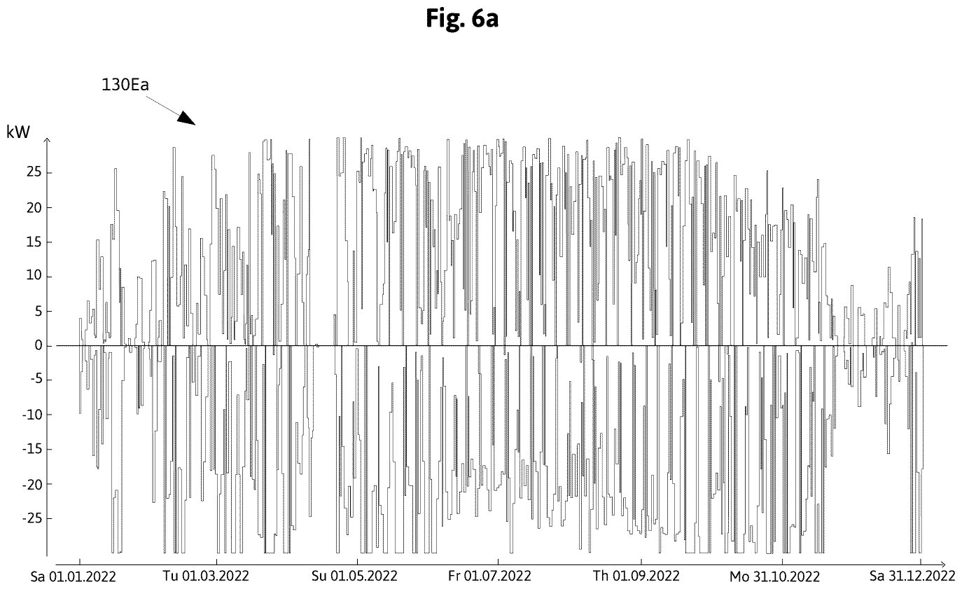

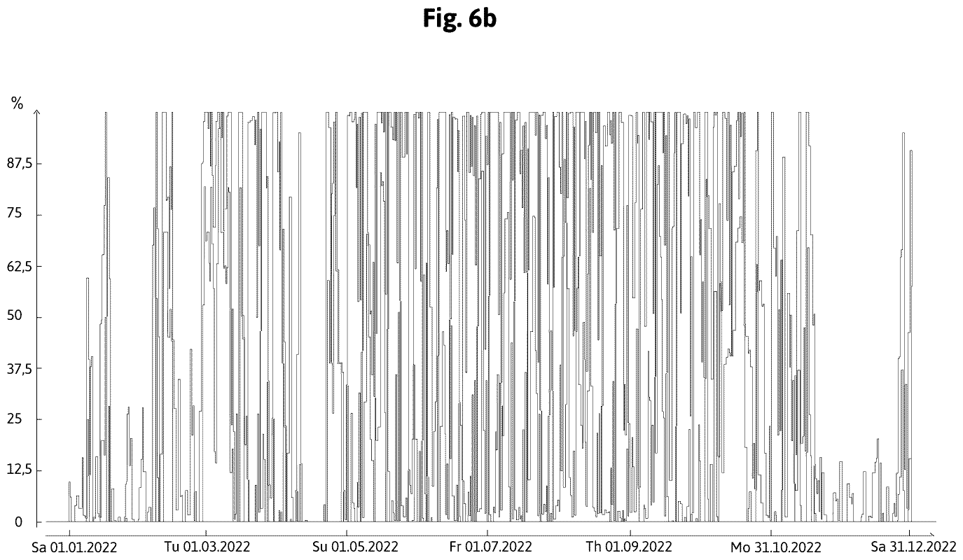

FIG. 6a shows a diagram of a loading power (values in the positive area of the power axis represent the intake of electrical energy E) and extraction power (values in the negative area of the power axis represent the release of electrical energy E), calculated as an example in the model calculation, of the third energy storage 130 of the exemplary system 1000, exemplarily formed as vanadium redox flow accumulator 130, in kW over the time range of a year (here the year 2022 as an example).

It becomes clear, especially when viewed together with FIG. 6b, that the third energy storage 130 is used primarily as a type of compensating storage for the short-term storage and the short-term delivery/provision of an amount of electrical energy 130Ea, so that a very fluctuating load level (see FIG. 6b) occurs and the same amount of energy 130Ea is stored in the third energy storage 130 and also released again within a short time (for example a few days). An “accumulation” of electrical energy E over a longer period of time is, for example, only a secondary aim here.

It can also be seen that, particularly in the cold months (January and February as well as November and December) of the year, significantly smaller amounts of energy 130Ea are stored in the third energy storage 130 and released again. This is due, for example, to the increased use of the available electrical energy E for heating the building 2000/2100, so that very often in this time range there is hardly any excess electrical energy E available, which can be stored directly as electrical energy quantity 130Ea.

The lack of storage (loading) and extraction (removal) processes as well as the reduction of the load level of the third storage 130 to essentially 0% in the time window in mid-April of the year can, for example, be due to the significantly increased use of the electrolyzer 310 to generate thermal energy T (thermal energy amount 310Ta) with constantly high utilization of the server (first, primary load-dependent energy converter 210) to generate the thermal energy amount 210Ta/b in this time window according to FIG. 4a, so that no or hardly any excess electrical energy E is available in this time window to be stored in the third energy storage 130.

FIG. 6b shows a diagram of a load level of the third energy storage 130 (exemplary vanadium redox flow accumulator 130) of the exemplary system 1000 in % over the time range of a year (here the year 2022 as an example), wherein the load level correlated with the loading and extracting processes according to FIG. 6a.

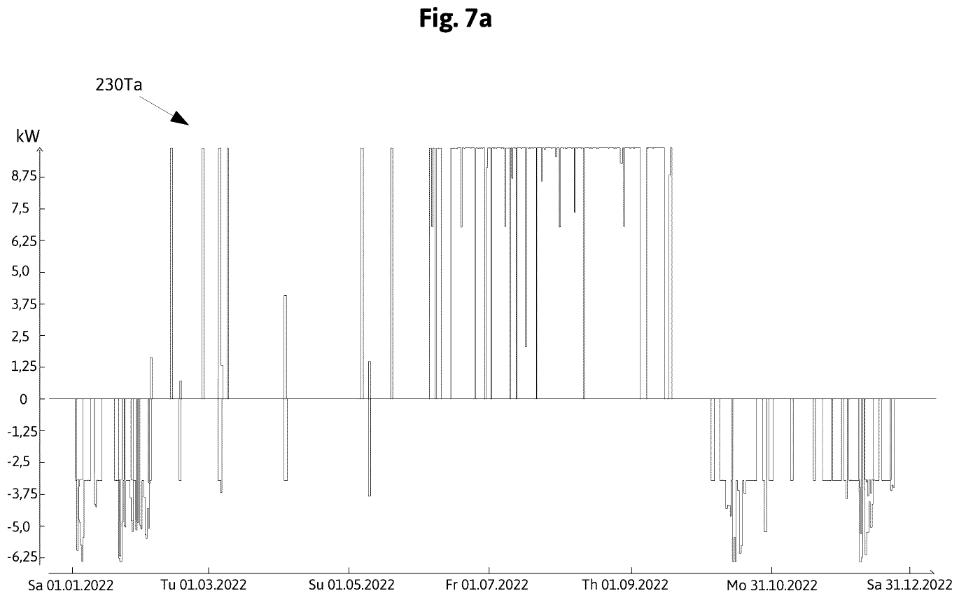

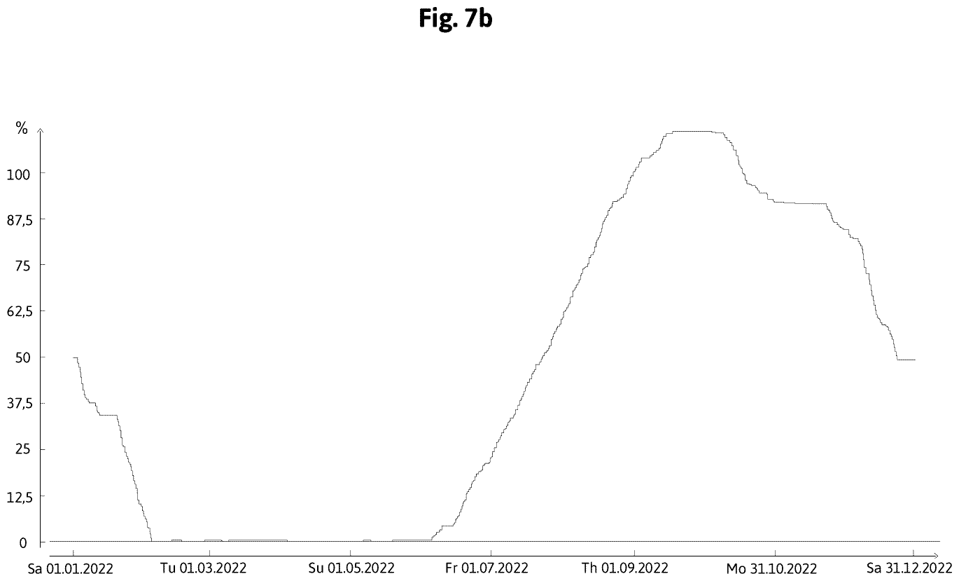

FIG. 7a shows a diagram of a loading power (values in the positive area of the power axis represent the absorption of thermal energy T) and extraction power (values in the negative area of the power axis represent the release of thermal energy T), calculated as an example in the model calculation, of the long-term thermal storage 230 of the exemplary system 1000 in kW over the time range of one year (here the year 2022 as an example).

In particular in the colder months (January and February and October to December), substantially only thermal energy amounts 230Ta are taken from the long-term thermal storage 230 and with the beginning of the warm months (approx. June to mid/end of September) this reverses and essentially only thermal energy quantities 230Ta are loaded/stored into the long-term thermal storage 230.

For extracting the thermal energy T from the thermal long-term storage 230, in particular the heat pump 510 is used for generating the amount of thermal energy 510Ta based on the thermal energy T provided by the storage with additional consumption of electrical energy E and feeding it into the exemplary system 1000. Therefore, the extraction processes from the long-term thermal storage 230 correlate with the heat emissions of the thermal energy quantity 510Ta occurring in FIGS. 4a to 4d.

The excess thermal energy T in the exemplary system 1000 is used to load/store the thermal long-term storage 230, as can be seen in particular in the periods from June to mid-September in FIGS. 4a to 4d. Since there is no removal/extraction of thermal energy T from the long-term thermal storage 230, the loading level of the long-term thermal storage 230 increases correspondingly quickly (see FIG. 7b). The loading of the long-term thermal storage 230 can be more than 100% (for example approximately 110%), which is possible, for example, with a long-term thermal storage 230 designed as an earth-coupled heat storage if, for example, it has a temperature of more than 25° C., which would be considered as 100% load level. However, it is generally recommended to bring about cooling of the storage 230 or the system 1000 in the event of a corresponding overheating of the thermal long-term storage 230, for example by loading the fifth energy storage 240 (chemical heat storage 240) with thermal energy T or by emergency cooling via the outdoor pool 700.

Only with the beginning of the colder months does the fill level of the long-term thermal storage 230 decrease, in some cases sharply (compare FIG. 7b).

In the period from around March to the end of May, only isolated loading and extraction processes of thermal energy T take place in the long-term thermal storage 230. This is due, for example, to the fact that there is initially no excess amount of heat (thermal energy T) in the exemplary system 1000 in this time range and, if there is a small deficit, the waste heat from the electrolyzer 310 or the fuel cell 330 is initially used to generate additional heat (see, for example, FIGS. 4a and 4b).

FIG. 7b shows a diagram of a load level of the long-term thermal storage 230 (exemplarily designed as an earth-coupled heat storage) of the exemplary system 1000 in % over the time range of a year (here the year 2022 as an example), wherein the load level correlates with the load and extraction processes according to FIG. 7a.

As already described in FIG. 7a, the thermal energy quantities 230Ta are stored in the long-term thermal storage 230, particularly in the warmer months (from June to mid-September), and the load level is therefore continuously increased, while in the colder months (January and February as well October to December) the load level is sometimes reduced rapidly.

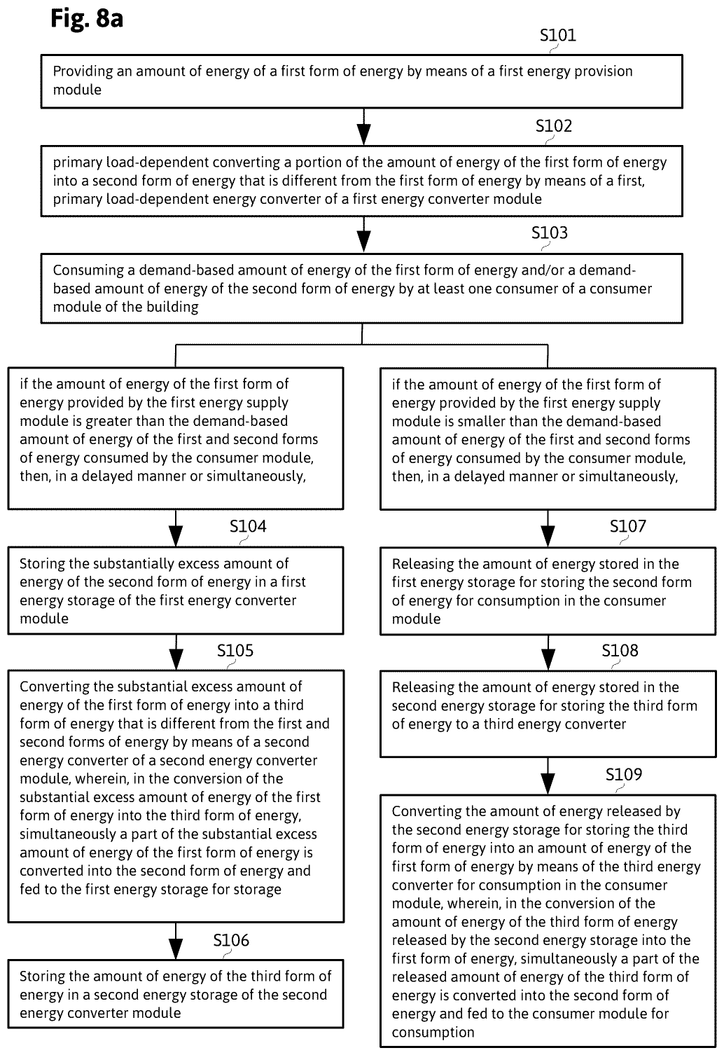

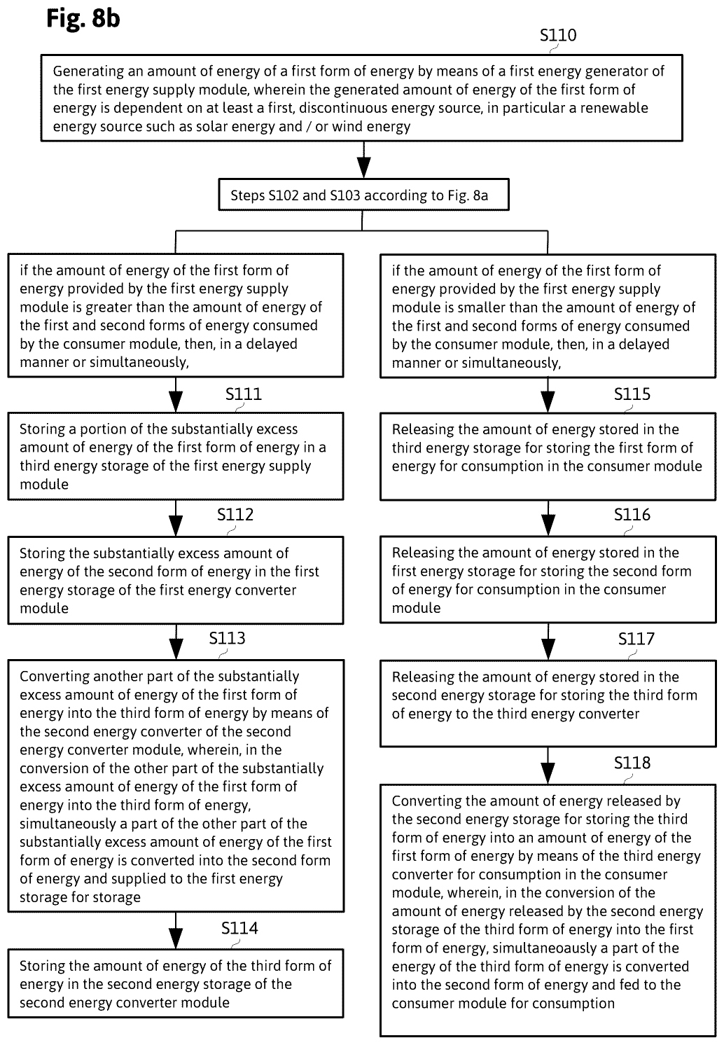

FIG. 8a shows an exemplary method for controlling an exemplary system 1000 for the continuous, demand-based energy supply of a building 2000/2100 by means of the control unit 900.

It should be pointed out at this point that the steps of the exemplary method described below and in particular the reference symbols used therein for the individual steps are not intended to represent or express any order of the individual steps. Rather, by way of example, a step with a lower reference number can take place after a step with a higher reference number and vice versa in the exemplary method.

In the method described by way of example, step S101 initially comprises providing an amount of energy of a first form of energy by means of a first energy supply module 100, wherein step S102 comprises converting a portion of the amount of energy of the first form of energy into a second form of energy that is different from the first form of energy, depending on the primary load, by means of a first, primary load-dependent energy converter 210 (e.g. server, machine tool, etc.) of a first energy converter module 200.

In step S103, a demand-based amount of energy of the first form of energy (for example electrical energy E) and/or a demand-based amount of energy of the second form of energy (for example thermal energy T) is consumed by at least one consumer of a consumer module 600, 800 of the building 2000/2100, wherein, if the amount of energy of the first form of energy provided by the first energy supply module 100 is greater than the demand-based amount of energy of the first and second forms of energy consumed by the consumer module 600, 800, then the substantially excess amount of energy of the second form is stored delayed or simultaneously in step S104 storing the substantially excess amount of energy of the second form of energy in a first energy storage 220/230 of the first energy converter module 200, in step S105 converting the substantially excess amount of energy of the first form of energy into a third form of energy (for example chemical energy C) that is different from the first and second forms of energy by means of a second energy converter 310 of a second energy converter module 300, wherein, during the conversion of the substantially excess amount of energy of the first form of energy into the third form of energy, a part of the substantially excess amount of energy of the first form of energy is simultaneously converted into the second form of energy and supplied to the first energy storage 220/230 for storage, and in in step S106, the amount of energy of the third form of energy is stored in a second energy storage 320 of the second energy converter module 300.

Additionally or alternatively, if the amount of energy of the first form of energy provided by the first energy supply module 100 is smaller than the demand-based amount of energy of the first and second forms of energy consumed by the consumer module 600/800, then in a delayed manner or simultaneously releasing, in step S107, the amount of energy stored in the first energy storage 220/230 for storing the second form of energy for consumption in the consumer module 600/800, releasing, in step S108, the amount of energy stored in the second energy storage 320 for storing the third form of energy to a third energy converter 330, and converting, in step S109, the amount of energy released by the second energy storage 320 for storing the third form of energy into an amount of energy of the first form of energy by means of the third energy converter 330 for consumption in the consumer module 600/800, wherein, when converting the amount of energy released by the second energy storage 320 of the third form of energy into the first form of energy at the same time, a part of the amount of energy released from the third form of energy is converted into the second form of energy and fed to the consumer module 600/800 for consumption.

FIG. 8b shows an exemplary method for controlling an exemplary system 1000 for the continuous, demand-based energy supply of a building 2000/2100 by means of the control unit 900, which can be used in addition to or as an alternative to the exemplary method as shown and described in FIG. 8a.

Furthermore, the exemplary method can have step S110, which comprises generating an amount of energy of a first form of energy by means of a first energy generator 110/120 of the first energy supply module 100, wherein the generated amount of energy of the first form of energy is dependent on at least a first, discontinuous energy source 10/20, in particular a renewable energy source such as solar energy 20 and/or wind energy 10.

In addition, if the amount of energy of the first form of energy provided by the first energy supply module 100 is greater than the amount of energy of the first and second forms of energy consumed by the consumer module 600/800, the exemplary method can carry out delayed or simultaneously storing, in step S111, a part of the substantially excess amount of energy of the first form of energy in a third energy storage 130 of the first energy supply module 100, storing, in step S112, the substantially excess amount of energy of the second form of energy in the first energy storage 220/230 of the first energy converter module 200, converting, in step S113, another part of the substantially excess amount of energy of the first form of energy into the third form of energy by means of the second energy converter 310 of the second energy converter module 300, wherein, when converting the other part of the substantially excess amount of energy of the first form of energy into the third form of energy at the same time, a part of the other part of the substantially excess amount of energy of the first form of energy is converted into the second form of energy and supplied to the first energy storage 220/230 for storage, and storing, in step S114, the amount of energy of the third form of energy in the second energy storage 320 of the second energy converter module 300.

Additionally or alternatively, if the amount of energy of the first form of energy provided by the first energy supply module 100 is smaller than the amount of energy of the first and the second forms of energy consumed by the consumer module 600/800, the exemplary method can carry out delayed or simultaneously releasing, in step S115, the amount of energy stored in the third energy storage 130 for storing the first form of energy for consumption in the consumer module 600/800, releasing, in step S116, the amount of energy stored in the first energy storage 220/230 for storing the second form of energy for consumption in the consumer module 600/800, releasing, in step S117, the amount of energy stored in the second energy storage 320 for storing the third form of energy to the third energy converter 330, and converting, in step S118, the amount of energy released by the second energy storage 320 for storing the third form of energy into an amount of energy of the first form of energy by means of the third energy converter 330 for consumption in the consumer module 600/800, wherein, when the amount of energy released by the second energy storage 320 of the third form of energy is converted into the first form of energy, a part of the amount of energy released from the third form of energy is simultaneously converted into the second form of energy and supplied to the consumer module 600/800 for consumption.

In addition, the exemplary method can be modified in such a way that storing the excess amount of energy of the different forms of energy in the energy storages, releasing the amount of energy of the different forms of energy stored in the energy storages and converting the excess or released amount of energy of the different forms of energy are carried out in a sequence controlled by the control unit 900, wherein the control unit 900 is configured to determine the sequence depending on a primary load (for example, carrying out arithmetic operations in a server/a computing unit, machining a workpiece on a machine tool, etc.) of the first, primary load-dependent energy converter 210 and a demand of the consumer module 600/800 to control an amount of energy of the first form of energy and an amount of energy of the second form of energy.

In addition, the exemplary method can be modified such that the first energy storage 220/230 comprises a short-term storage 220 for short-term storage of the amount of energy of the second form of energy and a long-term storage 230 for medium-term to long-term storage of the amount of energy of the second form of energy, wherein the control unit 900 is configured to control the storage of the amount of energy of the second form of energy in the first energy storage 220/230 so that primarily the amount of energy is stored in the short-term storage 220, and secondarily the amount of energy of the second form of energy is stored in the long-term storage 230.

In addition, the exemplary method can comprise generating, in step S119, an amount of energy of the third form of energy by means of a second energy generator 410 of a second energy supply module 400, wherein the generation of an amount of energy of the third form of energy by the second energy generator 410 depends on a second energy source 30 being different from at least one of the first energy sources 10, 20, 40, converting, in step S120, the generated amount of energy of the third form of energy into the second form of energy by means of a fourth energy converter 420 of the second energy supply module 400, and storing, in step S121, the amount of energy of the second form of energy in a fourth energy storage 430 of the second energy supply module 400, wherein the control unit 900 is configured to control the generation, conversion and storage of the amount of energy by the second energy supply module 400 depending on the energy demand of the consumer module 600/800 and the availability of the second energy source 30.

In addition, the exemplary method can comprise consuming, in step S122, an excess amount of energy of the second form of energy by an additional consumer 700 that is different from the at least one consumer of the consumer module 600/800 of the building 2000/2100, if the energy storage for storing the second form of energy has substantially no capacity for an additional amount of energy of the second form of energy, in order to reduce the total amount of energy in the exemplary system 1000, in particular the amount of energy of the second form of energy.

The exemplary method, like the exemplary system 1000, can be modified such that the first form of energy is electrical energy E, the second form of energy is thermal energy T and the third form of energy is chemical energy C.

In addition, the exemplary method can comprise allowing or stopping, in step S123, a supply of electrical energy from the public power grid 40 into the exemplary system 1000 by means of a connection of the exemplary system 1000 to the public power grid 40 or allowing or stopping, in step 124, a feed-in of electrical energy into the public power grid 40 from the exemplary system 1000 by means of the connection of the exemplary system 1000 to the public power grid 40.

It should be noted that only examples or exemplary embodiments of the present disclosure as well as technical advantages have been described in detail above with reference to the attached drawings. The present disclosure is in no way limited or limited to the exemplary embodiments described above and their embodiment features or their described combinations, but further includes modifications of the exemplary embodiments, in particular those that are achieved by modifying the features of the examples described or by combination or partial combination of one or more of the features of the examples described within the scope of protection of the independent claims.

### REFERENCE SIGNS LIST

10 first energy source/wind
20 first energy source/solar radiation/solar energy
30 second energy source/wood/biomass
40 energy suppliers/public power grid
45 energy suppliers/natural gas suppliers
50 computing capacity demand
100 first energy supply module
110 first energy generator/wind turbine
120 first energy generator/photovoltaic unit
130 third energy storage/electrical energy storage
200 first energy converter module
210 first energy converter (dependent on primary load)/computing unit
220 first energy storage/thermal short-term storage
230 first energy storage/thermal long-term storage
240 fifth energy storage/chemical heat storage
300 second energy converter module
310 second energy converter/electrolysis unit
320 second energy storage/chemical storage/hydrogen storage
330 third energy converter/fuel cell/combined heat and power plant
340 reversible fuel cell
400 second energy supply module
410 second energy generator/wood gasifier
420 fourth energy converter/wood gas burner
430 fourth energy storage
500 additional heating module
510 heat pump
520 heat cartridge
600 consumer module (thermal)
610 consumers/drinking water consumers
620 consumers/radiators/surface heating system
630 heat exchangers
640 heat network
650 consumers/surface heating system
700 additional consumers/outdoor pool
800 consumer module (electrical)
810 normal power demand
820 wall box
830 wall box
900 control unit
1000 system
2000 buildings
2100 outbuildings
E electrical energy
thermal energy
C chemical energy

1.-34. (canceled)

35. A system for continuous, demand-based energy supply of a building, comprising:
a first energy supply module for providing an amount of energy of a first form of energy,
a first energy converter module, which has a first, primary load-dependent energy converter for primary load-dependent conversion of a part of the provided amount of energy of the first form of energy into a second form of energy that is different from the first form of energy, and a first energy storage for storing an amount of energy of the second form of energy,
a consumer module that has at least one consumer of the building for consuming a demand-dependent amount of energy of the first form of energy and/or a demand-dependent amount of energy of the second form of energy, and
a control unit for controlling the modules of the system, the system further comprising
a second energy converter module which has a second energy converter for converting another part of the amount of energy of the first form of energy into a third form of energy different from the first and second forms of energy, wherein in the conversion of the other part of the amount of energy of the first form of energy into the third form of energy, at the same time a part of the other part of the amount of energy of the first form of energy is converted into the second form of energy,
a second energy storage for storing the amount of energy of the third form of energy, and
a third energy converter for converting a stored amount of energy of the third form of energy into the first form of energy, wherein when converting the stored amount of energy of the third form of energy into the first form of energy, a part of the amount of energy of the third form of energy is simultaneously converted into the second form of energy.

36. The System according to claim 35, wherein
the first energy supply module has a first energy generator for generating an amount of energy of the first form of energy, the generated amount of energy of the first form of energy being dependent on at least a first, discontinuous energy source, in particular a renewable energy source such as solar energy and/or wind energy.

37. The system according to claim 35, wherein
the first energy converter module has a fifth energy storage which is configured to convert an amount of energy of the second form of energy into an amount of energy of the third form of energy and to store it, wherein the fifth energy storage is configured to convert the stored amount of energy of the third form of energy back into an amount of energy of the second form of energy.

38. The system according to claim 35, wherein
storing the excess amount of energy of the different forms of energy in the energy storages, releasing the amount of energy of the different forms of energy stored in the energy storages and converting the excess or released amount of energy of the different forms of energy are carried out in a sequence controlled by the control unit,
wherein the control unit being configured to control the sequence depending on a primary load of the first, primary load-dependent energy converter and a demand of the consumer module for an amount of energy of the first form of energy and an amount of energy of the second form of energy.

39. The system according to claim 35, wherein
the first energy storage comprises a short-term storage for the short-term storage of the amount of energy of the second form of energy and a long-term storage for the medium-term to long-term storage of the amount of energy of the second form of energy,
wherein the short-term storage and the long-term storage are in direct operative connection with one another, so that an amount of energy of the second form of energy can be exchanged between the short-term storage and the long-term storage.

40. The system according to claim 35, wherein
the second energy converter for converting the first form of energy into the third form of energy and the third energy converter for converting the third form of energy into the first form of energy of the second energy converter module is an assembly that is configured to carry out the process of the conversion of the third form of energy into the first form of energy as a reversible process of converting the first form of energy into the third form of energy.

41. The system according to claim 35, further comprising:
a second energy supply module, which has a second energy generator for generating the third form of energy, the generation of an amount of energy of the third form of energy by the second energy generator being dependent on at least one second energy source that is different from the first energy source,
wherein this second energy supply module further has a fourth energy converter for converting the third form of energy into the second form of energy,
the second energy supply module has a fourth energy storage for storing the second form of energy, and
the fourth energy storage for storing the second form of energy is in no or in direct operative connection with the first energy storage for storing the second form of energy for exchanging an amount of energy of the second form of energy.

42. The system according to claim 35, wherein
the first form of energy is electrical energy,
the second form of energy is thermal energy, and
the third form of energy is chemical energy.

43. The system according to claim 42, wherein
the second energy converter is an electrolyzer which is set up to convert an amount of electrical energy into an amount of chemical energy.

44. The system according to claim 42, wherein
the third energy converter is a fuel cell which is configured to convert an amount of chemical energy into an amount of electrical energy.

45. The system according to claim 42, wherein
the third energy converter is a combined heat and power plant that is configured to convert an amount of chemical energy into an amount of electrical energy and/or an amount of thermal energy.

46. The system according to claim 42, wherein
the assembly is a reversible fuel cell, which in one process can convert an amount of electrical energy into an amount of chemical energy and can carry out this process in reverse, from chemical energy to electrical energy.

47. The system according to claim 42, wherein
the system also has a connection to the public power grid,
wherein the control unit is configured for allowing or stopping the supply of electrical energy from the public power grid into the system and for allowing or stopping the feeding of electrical energy from the system into the public power grid.

48. The system according to claim 35, wherein
the first energy converter is a computing unit that carries out computer operations as a primary load and converts the primary load-dependent electrical energy into thermal energy by carrying out the computer operations.

49. A method for controlling a system for the continuous, demand-based energy supply of a building by means of a control unit, comprising:
providing an amount of energy of a first form of energy by means of a first energy provision module,
converting, in a primary-load dependent manner, a portion of the amount of energy of the first form of energy into a second form of energy being different from the first form of energy by means of a first primary load-dependent energy converter of a first energy converter module,
consuming a demand-based amount of energy of the first form of energy and/or a demand-based amount of energy of the second form of energy by at least one consumer of a consumer module of the building,
wherein, if the amount of energy provided by the first energy supply module of the first form of energy is greater than the demand-based amount of energy of the first and second forms of energy consumed by the consumer module, then, in a delayed manner or simultaneously,
storing the substantially excess amount of energy of the second form of energy in a first energy storage of the first energy converter module,
converting the substantially excess amount of energy of the first form of energy into a third form of energy being different from the first and second forms of energy by means of a second energy converter of a second energy converter module, wherein during the conversion of the substantially excess amount of energy of the first form of energy into the third form of energy, a part of the substantially excess amount of energy of the first form of energy is simultaneously converted into the second form of energy and supplied to the first energy storage for storage, and
storing the amount of energy of the third form of energy in a second energy storage of the second energy converter module,
and/or
if the amount of energy of the first form of energy provided by the first energy supply module is smaller than the demand-based amount of energy of the first and the second form of energy consumed by the consumer module, then, in a delayed manner or simultaneously,
releasing the amount of energy stored in the first energy storage for storing the second form of energy for consumption in the consumer module,
releasing the amount of energy stored in the second energy storage for storing the third form of energy to a third energy converter, and
converting the amount of energy released by the second energy storage for storing the third form of energy into an amount of energy of the first form of energy by means of the third energy converter for consumption in the consumer module, wherein, when converting the amount of energy of the third form of energy released by the second energy storage into the first form of energy, at the same time a part of the amount of energy of the third form of energy being released is converted into the second form of energy and fed to the consumer module for consumption.

50. The method according to claim 49, comprising:
generating an amount of energy of a first form of energy by means of a first energy generator of the first energy supply module, wherein the generated amount of energy of the first form of energy being dependent on at least a first, discontinuous energy source, in particular a renewable energy source such as solar energy and/or wind energy.

51. The method according to claim 49, wherein,
if the amount of energy of the first form of energy provided by the first energy supply module is greater than the amount of energy of the first and second forms of energy consumed by the consumer module, then, in a delayed manner or simultaneously,
storing a portion of the substantially excess amount of energy of the first form of energy in a third energy storage of the first energy supply module,
storing the substantially excess amount of energy of the second form of energy in the first energy storage of the first energy converter module,
converting another part of the substantially excess amount of energy of the first form of energy into the third form of energy by means of the second energy converter module, wherein when converting the other part of the substantially excess amount of energy of the first form of energy into the third form of energy, a part of the other part of the substantially excess amount of energy of the first form of energy is simultaneously converted into the second form of energy and fed to the first energy storage for storage, and
storing the amount of energy of the third form of energy in the second energy storage of the second energy converter module,
and/or,
if the amount of energy of the first form of energy provided by the first energy supply module is smaller than the amount of energy of the first and second forms of energy consumed by the consumer module, then, in a delayed manner or simultaneously,
releasing the amount of energy stored in the third energy storage for storing the first form of energy for consumption in the consumer module,
releasing the amount of energy stored in the first energy storage for storing the second form of energy for consumption in the consumer module,
releasing the amount of energy stored in the second energy storage for storing the third form of energy to the third energy converter, and
converting the amount of energy released by the second energy storage device for storing the third form of energy into an amount of energy of the first form of energy by means of the third energy converter for consumption in the consumer module, wherein, when converting the amount of energy released by the second energy storage device of the third form of energy into the first form of energy, at the same time a part of the amount of energy of the third form of energy being released is converted into the second form of energy and fed to the consumer module for consumption.

52. The method according to claim 49, wherein
storing the excess amount of energy of the different forms of energy in the energy storages, releasing the amount of energy of the different forms of energy stored in the energy storages and converting the excess or released amount of energy of the different forms of energy are carried out in a sequence controlled by a control unit,
wherein the control unit is configured to control the sequence depending on a primary load of the first, primary load-dependent energy converter and a demand of the consumer module for an amount of energy of the first form of energy and an amount of energy of the second form of energy.

53. The method according to claim 49, wherein
the first form of energy is electrical energy,
the second form of energy is thermal energy, and
the third form of energy is chemical energy.

54. A control unit for controlling a system for continuous, demand-based energy supply of a building, wherein the control unit is further configured to control the system for the continuous, demand-based energy supply of the building, the control unit configured to:
provide an amount of energy of a first form of energy by means of a first energy provision module,
convert, in a primary-load dependent manner, a portion of the amount of energy of the first form of energy into a second form of energy being different from the first form of energy by means of a first primary load-dependent energy converter of a first energy converter module,
consume a demand-based amount of energy of the first form of energy and/or a demand-based amount of energy of the second form of energy by at least one consumer of a consumer module of the building,
wherein, if the amount of energy provided by the first energy supply module of the first form of energy is greater than the demand-based amount of energy of the first and second forms of energy consumed by the consumer module, then, in a delayed manner or simultaneously,
store the substantially excess amount of energy of the second form of energy in a first energy storage of the first energy converter module,
convert the substantially excess amount of energy of the first form of energy into a third form of energy being different from the first and second forms of energy by means of a second energy converter of a second energy converter module, wherein during the conversion of the substantially excess amount of energy of the first form of energy into the third form of energy, a part of the substantially excess amount of energy of the first form of energy is simultaneously converted into the second form of energy and supplied to the first energy storage for storage, and
store the amount of energy of the third form of energy in a second energy storage of the second energy converter module,
and/or
if the amount of energy of the first form of energy provided by the first energy supply module is smaller than the demand-based amount of energy of the first and the second form of energy consumed by the consumer module, then, in a delayed manner or simultaneously,
release the amount of energy stored in the first energy storage for storing the second form of energy for consumption in the consumer module,
release the amount of energy stored in the second energy storage for storing the third form of energy to a third energy converter, and
convert the amount of energy released by the second energy storage for storing the third form of energy into an amount of energy of the first form of energy by means of the third energy converter for consumption in the consumer module, wherein, when converting the amount of energy of the third form of energy released by the second energy storage into the first form of energy, at the same time a part of the amount of energy of the third form of energy being released is converted into the second form of energy and fed to the consumer module for consumption.

55. A non-transitory computer readable medium, storing instructions for execution of a process for controlling a system for the continuous, demand-based energy supply of a building, the instructions comprising:
providing an amount of energy of a first form of energy by means of a first energy provision module,
converting, in a primary-load dependent manner, a portion of the amount of energy of the first form of energy into a second form of energy being different from the first form of energy by means of a first primary load-dependent energy converter of a first energy converter module,
consuming a demand-based amount of energy of the first form of energy and/or a demand-based amount of energy of the second form of energy by at least one consumer of a consumer module of the building,
wherein, if the amount of energy provided by the first energy supply module of the first form of energy is greater than the demand-based amount of energy of the first and second forms of energy consumed by the consumer module, then, in a delayed manner or simultaneously,
storing the substantially excess amount of energy of the second form of energy in a first energy storage of the first energy converter module,
converting the substantially excess amount of energy of the first form of energy into a third form of energy being different from the first and second forms of energy by means of a second energy converter of a second energy converter module, wherein during the conversion of the substantially excess amount of energy of the first form of energy into the third form of energy, a part of the substantially excess amount of energy of the first form of energy is simultaneously converted into the second form of energy and supplied to the first energy storage for storage, and
storing the amount of energy of the third form of energy in a second energy storage of the second energy converter module,
and/or
if the amount of energy of the first form of energy provided by the first energy supply module is smaller than the demand-based amount of energy of the first and the second form of energy consumed by the consumer module, then, in a delayed manner or simultaneously,
releasing the amount of energy stored in the first energy storage for storing the second form of energy for consumption in the consumer module,
releasing the amount of energy stored in the second energy storage for storing the third form of energy to a third energy converter, and
converting the amount of energy released by the second energy storage for storing the third form of energy into an amount of energy of the first form of energy by means of the third energy converter for consumption in the consumer module, wherein, when converting the amount of energy of the third form of energy released by the second energy storage into the first form of energy, at the same time a part of the amount of energy of the third form of energy being released is converted into the second form of energy and fed to the consumer module for consumption.
